(19) United States
(12) Patent Application Publication
(10) Pub. No.: US 2013/0182013 A1
(43) Pub. Date: Jul. 18, 2013

(54) INFORMATION PROCESSING APPARATUS AND PROGRAM

(71) Applicants: Satoshi NAGATA, Tokyo (JP); Shigeharu Kondo, Kanagawa (JP); Satoru Inoue, Tokyo (JP); Atsuko Shimoda, Tokyo (JP); Naoki Masuda, Kanagawa (JP); Wonjoon Cho, Tokyo (JP); Hideaki Kamei, Chiba (JP); Kenichi Odashima, Kanagawa (JP); Yusuke Nakashita, Tokyo (JP)

(72) Inventors: Satoshi NAGATA, Tokyo (JP); Shigeharu Kondo, Kanagawa (JP); Satoru Inoue, Tokyo (JP); Atsuko Shimoda, Tokyo (JP); Naoki Masuda, Kanagawa (JP); Wonjoon Cho, Tokyo (JP); Hideaki Kamei, Chiba (JP); Kenichi Odashima, Kanagawa (JP); Yusuke Nakashita, Tokyo (JP)

(73) Assignee: SONY CORPORATION, Tokyo (JP)

(21) Appl. No.: 13/548,811

(22) Filed: Jul. 13, 2012

(30) Foreign Application Priority Data
Jul. 26, 2011 (JP) 2011-163673

(51) Int. Cl. G09G 5/377

(52) U.S. Cl. CPC G09G 5/377
USPC 345/641

(57) ABSTRACT

An apparatus includes an input unit and a control unit. The input unit is configured to receive an input from a user. The control unit is configured to control a display to display an image and an image mark, move over the image to a position indicated by the input unit, and display an indicator showing an amount of time until the image mark is fixed to a current location of the image mark on the image.

### CROSS-REFERENCE TO RELATED APPLICATIONS

The present application is based upon and claims the benefit of priority under 35 U.S.C. §119 of Japanese Priority Patent Application JP 2011-163673 filed in the Japanese Patent Office on Jul. 26, 2011, the entire contents of which are hereby incorporated by reference.

### BACKGROUND

The present technology relates to an information processing apparatus and a non-transitory computer readable medium encoded with a program, and more particularly, to an information processing apparatus and a non-transitory computer readable medium encoded with a program capable of making it possible to share content in a more enjoyable manner.

Personal computers, mobile information processing terminals, and the like having communication functions are gaining in popularity as the Internet is becoming more and more popular. For example, various web pages that are open to public through server apparatuses on the Internet are being utilized domestically. The web pages include various pieces of digitized information such as photographs (still image information), movies (moving image information), diary information called blogs, comment information, book review information, schedule information, and mail information.

A lot of websites that provide web pages through the server apparatuses on the Internet have been established, and display information such as text information, still image information, and moving image information is displayed by obtaining target webpages using a browser, a viewer, or the like.

In these years, social networking services (SNSs) are becoming more and more popular. An SNS provides, for example, a website as a place in which new human relations are established through connections such as hobbies, tastes, and places of residence.

An SNS provides a function of making a user's profile and photographs public, a function of sending a message to another member without making the user's mail address known, a function of registering a newly made “friend”, a function of introducing a friend to another friend, and the like. A bulletin board system that can be viewed only by members or friends and the like are also provided. For example, a general user can develop various applications and make the applications public or place various advertisements such as one for used goods for sale and one for help.

Furthermore, an SNS also provides a function of uploading photographs and moving images and the like. By making the uploaded photographs and moving image public, so-called posting of content is performed. At this time, for example, it is possible to make settings such that the content can be viewed only by members or friends.

In many cases, content posted by a user is evaluated. A user who desires that content posted thereby be evaluated, for example, can set a graphical user interface (GUI) for evaluation in a posting web page thereof. For example, when a person who has viewed the posted content has clicked a button, an indication such as “Mr. XX has evaluated” is displayed in the web page of the SNS.

In addition, a technique has been proposed in which a process such as one for arranging pieces of display information regarding pieces of content along a time axis is executed in accordance with time information included in each piece of content and the pieces of display information are displayed on a screen (for example, refer to Japanese Unexamined Patent Application Publication No. 2008-134866).

### SUMMARY

Although it has been possible to evaluate posted content in the related art, it has been difficult to indicate which part of the content has been evaluated.

For example, if the posted image is a still image obtained by capturing an image of a user, the image of the user, who is the main subject of the image, is not necessarily evaluated, but an image of a pet captured together with the image of the user or an image of a celebrity that has been accidentally captured in the background can often be evaluated. If information indicating which part of content has been evaluated by each person who has viewed the content can be displayed together with the content, a more enjoyable SNS can be provided.

It is desirable to make it possible to share content in a more enjoyable manner.

Accordingly, the present invention broadly comprises an apparatus, a method, a non-transitory computer readable medium encoded with a program which causes the processor to perform the method, and a system including multiple apparatuses. In one embodiment, the apparatus includes an input unit and a control unit. The input unit is configured to receive an input from a user. The control unit is configured to control a display to display an image and an image mark, move the image mark over the image to a position indicated by the input unit, and display an indicator showing an amount of time until the image mark is fixed to a current location of the image mark on the image.

An information processing apparatus according to another embodiment of the present technology includes an image registration unit that registers an image to an external apparatus, an image editing unit that attaches a mark to an arbitrary position in the registered image, a communication control unit that uploads, to the external apparatus, positional information indicating the position to which the mark has been attached and that downloads, from the external apparatus, the image registered to the external apparatus and the positional information regarding the mark attached to the registered image, and a display control unit that displays, together with the downloaded image, the mark at a position corresponding to the positional information and that superimposes the mark upon the downloaded image.

The image registration unit can register the image to the external apparatus by transmitting data regarding the image to the external apparatus while associating the data regarding the image with a thread set in the external apparatus in advance and by storing the data regarding the image in the external apparatus.

The image editing unit can attach one of a plurality of marks set in advance to an arbitrary position in the registered image. The communication control unit can upload, to the external apparatus, an identifier of the mark and identification information regarding a user who has performed an operation for attaching the mark together with the positional information. The display control unit can display and superimpose the mark corresponding to the identifier at a position corresponding to the positional information and can also display and superimpose the identification information regarding the user at a position close to the mark.

When the positional information has been uploaded to the external apparatus, the communication control unit can provide feedback, to a user, indicating that the upload has been executed.

The external apparatus can store time information indicating time at which the positional information has been uploaded. The communication control unit can download the time information together with the positional information. The display control unit can display and superimpose the mark at a position corresponding to the mark in an order corresponding to the time identified by the time information.

The display control unit can delete the mark that has been displayed and superimposed when a certain period of time set in advance has elapsed.

The display control unit can display or delete all marks attached to the image at once on the basis of an instruction issued by a user.

A download instruction unit that instructs the communication control unit to download the positional information is further included. When instructed to download the positional information, the communication control unit can download the positional information from the external apparatus. The display control unit can display the mark and superimpose the mark upon the image that has been downloaded in advance on the basis of the downloaded positional information.

A program according to another embodiment of the present technology is a program for causing a computer to function as an information processing apparatus including an image registration unit that registers an image to an external apparatus, an image editing unit that attaches a mark to an arbitrary position in the registered image, a communication control unit that uploads, to the external apparatus, positional information indicating the position to which the mark has been attached and that downloads, from the external apparatus, the image registered to the external apparatus and the positional information regarding the mark attached to the registered image, and a display control unit that displays, together with the downloaded image, the mark at a position corresponding to the positional information and that superimposes the mark upon the downloaded image.

According to another embodiment of the present technology, an image is registered to an external apparatus, a mark is attached to an arbitrary position in the registered image, positional information indicating the position to which the mark has been attached is uploaded to the external apparatus, the image registered to the external apparatus and the positional information regarding the mark attached to the registered image are downloaded from the external apparatus, and the mark is displayed and superimposed at a position corresponding to the positional information together with the downloaded image.

An information processing apparatus according to a further embodiment of the present technology includes a registration reception unit that receives registration of an image executed by an external terminal, and a communication control unit that receives upload of positional information indicating a position to which a mark has been attached by the external terminal and corresponding to an arbitrary position in the registered image and that also receives download of the registered image and the positional information regarding the mark attached to the registered image to the external terminal.

The registration reception unit can receives the registration of the image by storing data regarding the image transmitted from the external terminal while associating the data regarding the image with a thread set in advance.

The external terminal can attach one of a plurality of marks set in advance to an arbitrary position in the registered image. The communication control unit can receive upload of an identifier of the mark and identification information regarding a user who has performed an operation for attaching the mark uploaded from the external terminal together with the positional information.

Time information indicating time at which the external terminal has uploaded the positional information can be stored while associated with the positional information. The communication control unit can receive download of the time information together with the positional information.

A request judgment unit that judges whether or not a request to download the positional information has been received from the external terminal is further included. If it is judged that the request to download the positional information has been received, the communication control unit can receive download of the positional information corresponding to the image, for which download has been received in advance.

A program according to a further embodiment of the present technology is a program for causing a computer to function as an information processing apparatus including a registration reception unit that receives registration of an image executed by an external terminal, and a communication control unit that receives upload of positional information indicating a position to which a mark has been attached by the external terminal and corresponding to an arbitrary position in the registered image and that also receives download of the registered image and the positional information regarding the mark attached to the registered image to the external terminal.

According to a further embodiment of the present technology, registration of an image executed by an external terminal is received, upload of positional information indicating a position to which a mark has been attached by the external terminal and corresponding to an arbitrary position in the registered image is received, and download of the registered image and the positional information regarding the mark attached to the registered image to the external terminal is received.

According to the present technology, it is possible to share content in a more enjoyable manner.

### BRIEF DESCRIPTION OF THE DRAWINGS

FIG. 1 is a diagram illustrating an example of the configuration of an information processing system according to an embodiment of the present technology;

FIG. 2 is a block diagram illustrating an example of the configuration of a terminal illustrated in FIG. 1;

FIG. 3 is a block diagram illustrating an example of the configuration of a server illustrated in FIG. 1;

FIG. 4 is a diagram illustrating an example of a screen displayed on a display of the terminal;

FIG. 5 is a diagram illustrating another example of the screen displayed on the display of the terminal;

FIG. 6 is a diagram illustrating yet another example of the screen displayed on the display of the terminal;

FIG. 7 is a diagram illustrating yet another example of the screen displayed on the display of the terminal;

FIG. 8 is a diagram illustrating yet another example of the screen displayed on the display of the terminal;

FIG. 9 is a diagram illustrating yet another example of the screen displayed on the display of the terminal;

FIG. 10 is a diagram illustrating yet another example of the screen displayed on the display of the terminal;

FIG. 11 is a diagram illustrating yet another example of the screen displayed on the display of the terminal;

FIG. 12 is a diagram illustrating yet another example of the screen displayed on the display of the terminal;

FIG. 13 is a diagram illustrating yet another example of the screen displayed on the display of the terminal;

FIG. 14 is a diagram illustrating yet another example of the screen displayed on the display of the terminal;

FIG. 15 is a diagram illustrating yet another example of the screen displayed on the display of the terminal;

FIG. 16 is a flowchart illustrating an example of a posting process;

FIG. 17 is a flowchart illustrating an example of a process for receiving posting;

FIG. 18 is a flowchart illustrating an example of a process for attaching a mark;

FIG. 19 is a flowchart illustrating an example of a process for receiving attachment of a mark;

FIG. 20 is a flowchart illustrating an example of a process for displaying an image; and

FIG. 21 is a flowchart illustrating an example of a process for transmitting data.

### DETAILED DESCRIPTION OF EMBODIMENTS

Embodiments of the present technology disclosed herein will be described hereinafter with reference to the drawings.

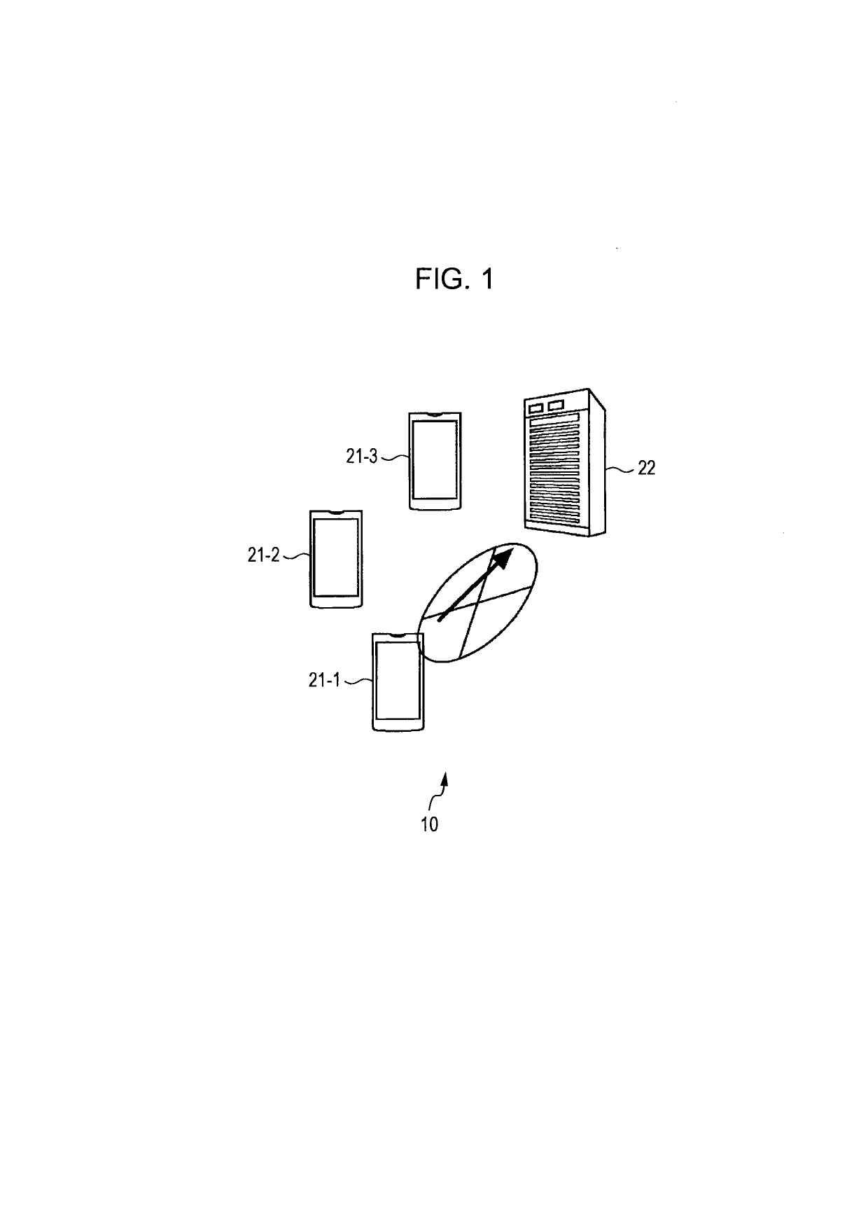

FIG. 1 is a diagram illustrating an example of the configuration of an information processing system 10 according to an embodiment of the present technology. In the example illustrated in FIG. 1, the information processing system 10 is configured by connecting terminals 21-1 to 21-3 to a server 22 through a network.

In the information processing system 10, for example, an SNS is provided. The SNS provides, for example, a website as a place in which new human relations are established through connections such as hobbies, tastes, and places of residence. In general, an SNS is provided as a membership service, and a certain account is assigned to a member.

An SNS provides a function of making a user's profile and photographs public, a function of sending a message to another member without making the user's mail address known, a function of registering a newly made “friend”, a function of introducing a friend to another friend, and the like. A bulletin board system that can be viewed only by members or friends and the like are also provided. For example, a general user can develop various applications and make the applications public or place various advertisements such as one for used goods for sale and one for help.

In FIG. 1, the terminals 21-1 to 21-3 are, for example, smartphones, personal computers, or the like owned by users. When the terminals 21-1 to 21-3 are not particularly distinguished from one another, the terminal 21-1 to 21-3 are collectively called the terminals 21.

The terminals 21 can, for example, access the server 22 through the network such as the Internet, and can then download content stored in the server 22 and display the content. In addition, the terminals 21 can, for example, upload data regarding content such as an image captured by a user to the server 22 through the network.

The server 22 includes, for example, a database that stores various pieces of data relating to an SNS.

Although only the terminals 21-1 to 21-3 are illustrated in FIG. 1, there are much more terminals in practice. Although only the server 22 is illustrated in FIG. 1, the functions of an SNS may be realized by a plurality of servers.

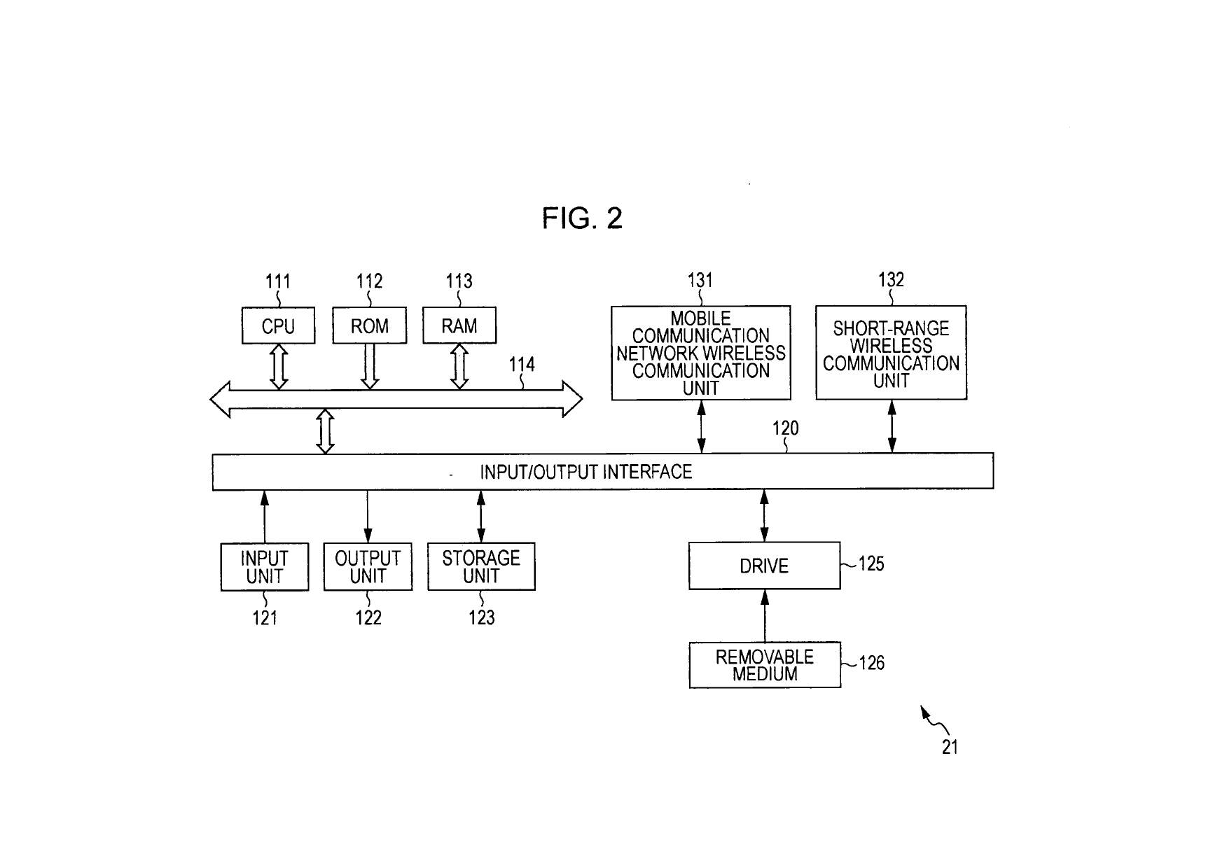

FIG. 2 is a block diagram illustrating an example of the configuration of each of the terminals 21 illustrated in FIG. 1.

In FIG. 2, a central processing unit (CPU) 111 of a terminal 21 executes various processes in accordance with programs stored in a read-only memory (ROM) 112 and programs loaded from a storage unit 123 into a random-access memory (RAM) 113. Data to be used by the CPU 111 to execute various processes is also stored in the RAM 113 as necessary.

The CPU 111, the ROM 112, and the RAM 113 are connected to one another through a bus 114. An input/output interface 120 is also connected to the bus 114.

An input unit 121 such as a keyboard or a mouse, a display such as a liquid crystal display (LCD), an output unit 122 such as a speaker, and the storage unit 123 such as a hard disk or a flash memory are connected to the input/output interface 120.

In addition, a drive 125 is connected to the input/output interface 120 as necessary, a removable medium 126 such as a magnetic disk, an optical disk, a magneto-optical disk, or a semiconductor memory is mounted on the input/output interface 120 as necessary, and a computer program read from the removable medium 126 is installed in the storage unit 123 as necessary.

Furthermore, a mobile communication network wireless communication unit 131 and a short-range wireless communication unit 132 are connected to the input/output interface 120.

The mobile communication network wireless communication unit 131 is a wireless communication device that wirelessly communicates with a wireless base station, which is not illustrated, and that executes communication through a mobile communication network. The mobile communication network wireless communication unit 131 uses, for example, a frequency band of 2 GHz and is utilized for various communication applications such as the Internet connection using data communication of up to 2 Mbps. For example, the wireless communication executed by the mobile communication network wireless communication unit 131 is used to download content data, communicate with the terminal 21, and the like. The mobile communication network wireless communication unit 131 is, for example, assumed to be configured as a device capable of realizing communication using a communication method according to the so-called third generation mobile telecommunications.

The short-range wireless communication unit 132 is a short-range wireless communication device such as, for example, a Bluetooth (registered trademark; also referred to as BT) device or a device according to the Institute of Electrical and Electronic Engineers (IEEE) 802.11x standards. Here, short-range wireless communication refers to local (narrow area) wireless communication whose maximum communication distance is about several meters to tens of meters. An arbitrary communication standard may be adopted. For example, when the short-range wireless communication unit 132 executes BT communication, communication is executed at a maximum communication speed of 3 Mbps (version 2.0+EDR or later) using a 2.4 GHz band through an antenna.

For example, when communication with the server 22 is executed through the network such as the Internet, a communication process is executed by the mobile communication network wireless communication unit 131 or the short-range wireless communication unit 132.

Each component of the terminal 21 is controlled by the CPU 111. An execution binary code for a control program has been saved to the ROM 112 or the storage unit 123, and stacks and heap areas for various arithmetic operations are expanded into the RAM 113.

In addition to the above-described function blocks, for example, a digital camera function may be provided for the terminal 21.

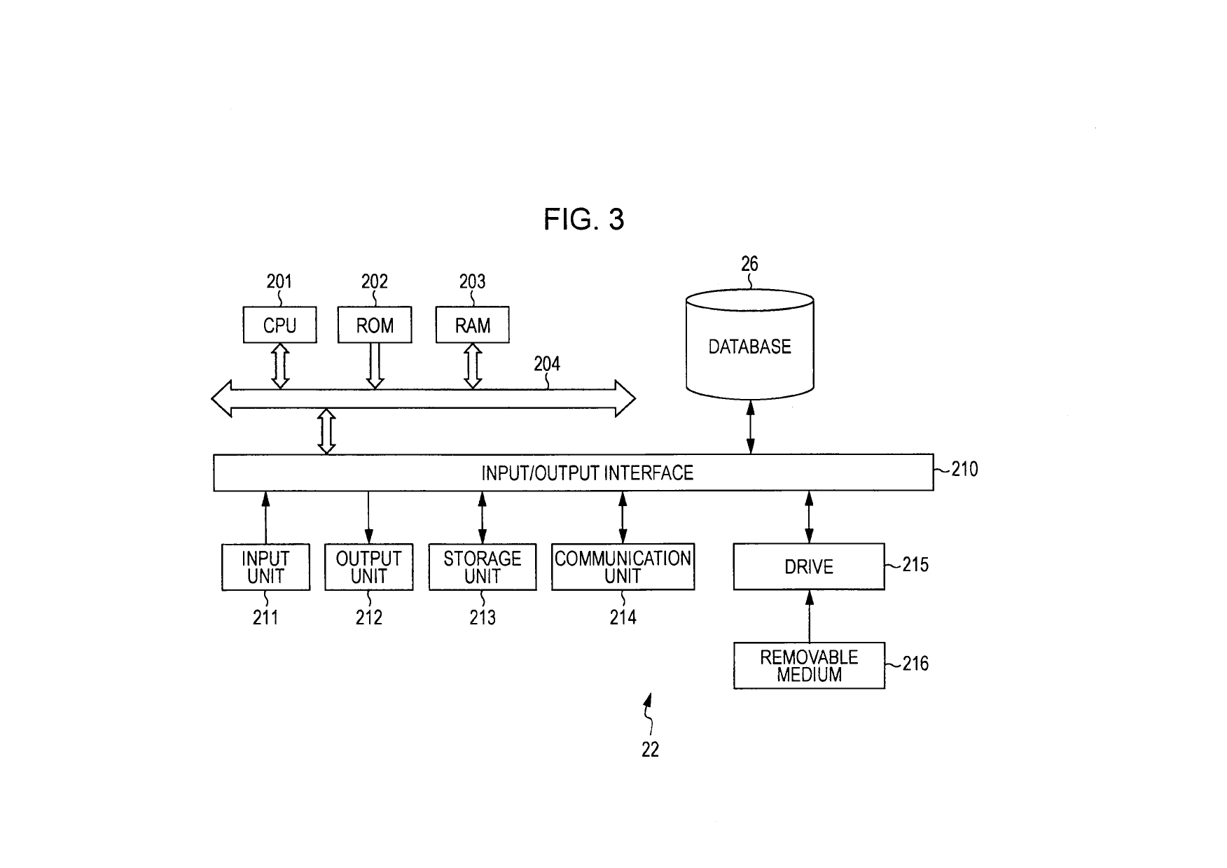

FIG. 3 is a block diagram illustrating an example of the configuration of the server 22 illustrated in FIG. 1.

As illustrated in FIG. 3, a log collection server 27 includes, as with the terminal 21, a CPU 201, a ROM 202, and a RAM 203 that are connected to one another through a bus 204. An input/output interface 210 is connected to the bus 204.

As with the terminal 21, an input unit 211, an output unit 212, a storage unit 213, and a drive 215 for a removable medium 216 are connected to the input/output interface 210.

The CPU 201, the ROM 202, the RAM 203, the bus 204, the input/output interface 210, the input unit 211, the output unit 212, the storage unit 213, the drive 215, and the removable medium 216 illustrated in FIG. 3 correspond to the CPU 111, the ROM 112, the RAM 113, the bus 114, the input/output interface 120, the input unit 121, the output unit 122, the storage unit 123, the drive 125, and the removable medium 126, respectively, illustrated in FIG. 2.

The server 22 also includes a communication unit 214 connected to the input/output interface 210. The communication unit 214 is a communication device that communicates with another device through a network. For example, the communication unit 214 is connected to a cable network and utilized to communicate with the terminals 21-1 to 21-3.

A database 26 is also connected to the input/output interface 210.

For example, various pieces of data relating to content or the like transmitted from the terminals 21-1 to 21-3 are replaced, for example, by a data set having a certain format and sequentially stored in the database 26.

In an SNS realized by the information processing system 10, a function of uploading photographs and moving images and the like are also provided. By making the uploaded photographs and moving image public, so-called posting of content is performed. At this time, for example, it is possible to make settings such that the content can be viewed in the SNS only by members or friends.

Furthermore, in the SNS realized by the information processing system 10, it is possible to evaluate content posted by a user.

Next, the evaluation of content posted by the user on the SNS realized by the information processing system 10 will be described with reference to screens displayed on a display of the terminal 21. Here, an example in which an image such as a photograph or a moving image is posted as content and evaluated will be described.

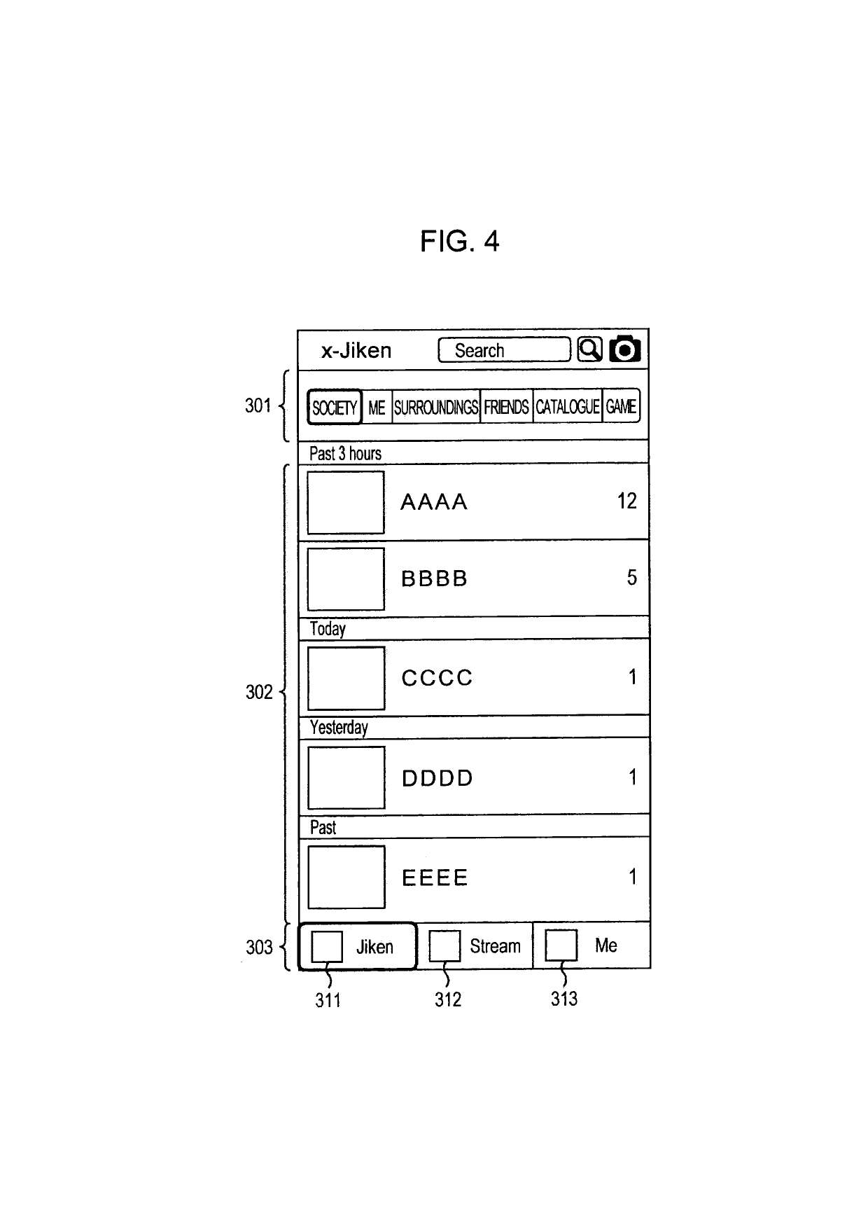

FIG. 4 is a diagram illustrating an example of a screen displayed on the display of the terminal 21 when the user has accessed the server 22 to be provided with an SNS. Here, it is assumed that the terminal 21 have logged in an account of the SNS in advance.

In a category display section 301 illustrated in FIG. 4, categories of threads, which will be described later, are displayed. In the example illustrated in FIG. 4, categories of “society”, “me”, “surroundings”, “friends”, “catalogue”, and “game” are displayed. Each category is configured as a GUI component (button). In this example, the “society” button has been selected and threads belonging to the category of “society” are displayed in a thread display section 302.

In the thread display section 302 illustrated in FIG. 4, a certain number of threads are displayed in accordance with the selection of a button displayed in the category display section 301. A thread indicates, for example, a common topic and has a certain title. In this example, threads having titles “AAAA”, “BBBB”, “CCCC”, “DDDD”, and “EEEE” are displayed. In practice, for example, a title such as “new home of the Satos”, “wedding of Kenji”, or the like is attached to each thread.

In the SNS, threads are referred to as “Jiken”. For example, users that have been registered to the SNS as members can freely create threads, and the created threads are disclosed to the members. When a thread is created, for example, one of the above-mentioned categories is selected by a user and the thread is classified in the server 22 in accordance with the category.

The user, who is a member of the SNS, then refers to the title of the thread and uploads images or the like relating to the title to the server 22. The thread and data regarding the images are, for example, stored in the database 26 of the server 22.

For example, one of uploaded images is displayed on the left of each title in the thread display section 302 as a thumbnail of each thread. In addition, the number of images (content) posted in each thread is displayed on the right of each title in the thread display section 302. In the example illustrated in FIG. 4, twelve images have been posted in the thread having the title “AAAA”, and five images have been posted in the thread having the title “BBBB”. One image has been posted in each of the threads having the titles “CCCC”, “DDDD”, and “EEEE”, respectively.

A plurality of display switching buttons are displayed in a display switching button display section 303. In this example, display switching buttons 311 to 313 named “Jiken”, “Stream”, and “Me”, respectively, are displayed. In the example illustrated in FIG. 4, the display switching button 311 has been selected and, in this case, a certain number of threads are displayed in the thread display section 302 in accordance with the selection of a button displayed in the category display section 301.

For example, when the user has clicked the title of one of the threads displayed in the thread display section 302 illustrated in FIG. 4, the corresponding thread is selected. A list of images posted in the selected thread is displayed on the display of the terminal 21.

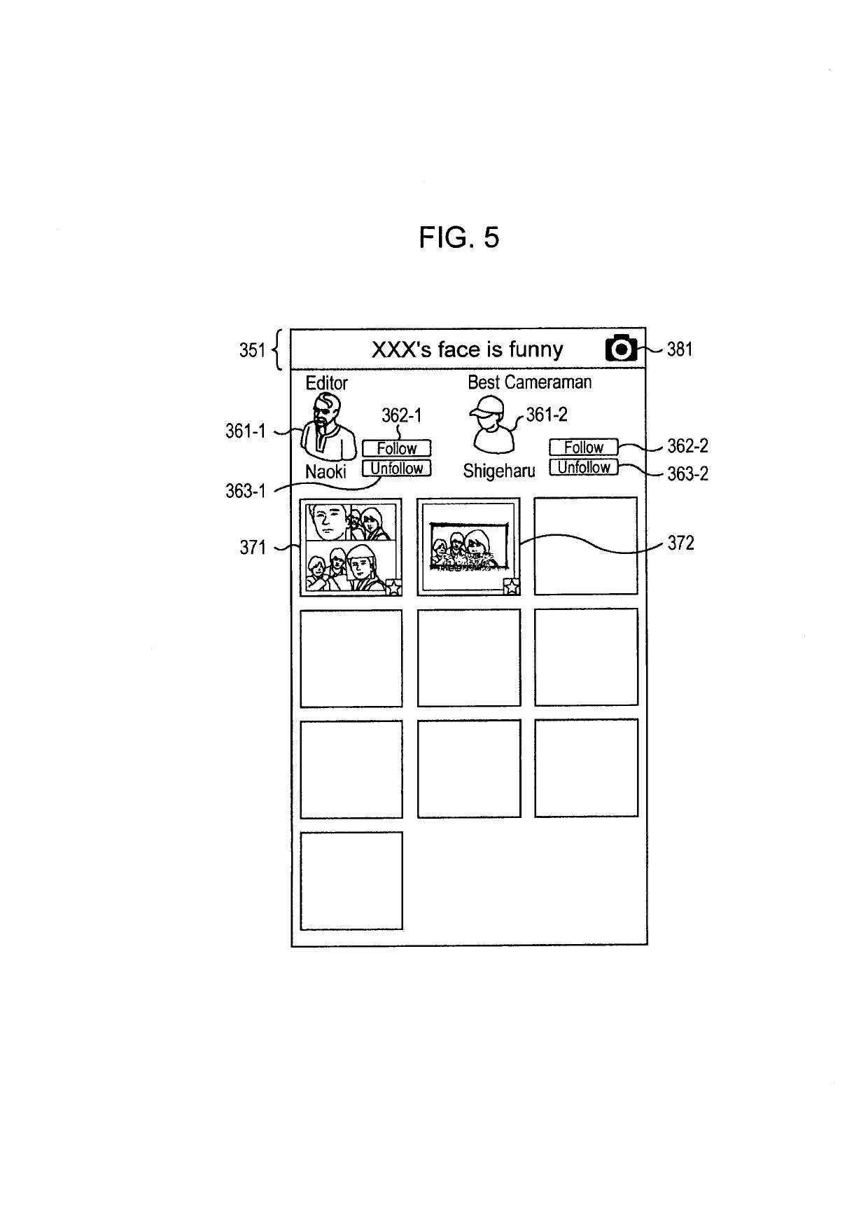

FIG. 5 is a diagram illustrating an example of a screen displayed on the display of the terminal 21 at a time when one of the threads displayed in the thread display section 302 illustrated in FIG. 4 has been selected. In a title display section 351 illustrated in FIG. 5, the title of the selected thread is displayed. In this example, “XXX's face is funny” is displayed.

The “editor” and the “best cameraman” are displayed under the title display section 351 illustrated in FIG. 5.

Here, the “editor” is the user who has created the thread. In this example, a user having a handle name “Naoki” is the editor and a user icon 361-1 of the user is displayed. By pressing a button 362-1 or 363-1 displayed on the right of the user icon 361-1, it is possible to register or delete, respectively, the user corresponding to the user icon 361-1 to or from a “friend stream”, which will be described later.

The “best cameraman” is a user who has contributed most in the thread. Here, the degree of contribution is determined, for example, in accordance with the number of images the user has posted, the evaluation of the posted images, which will be described later, and the like. In this example, a user having a handle name “Shigeharu” is the “best cameraman”, and a user icon 361-2 of the user is displayed. By pressing a button 362-2 or 363-2 displayed on the right of the user icon 361-2, it is possible to register or delete, respectively, the user corresponding to the user icon 361-2 to or from the “friend stream”, which will be described later.

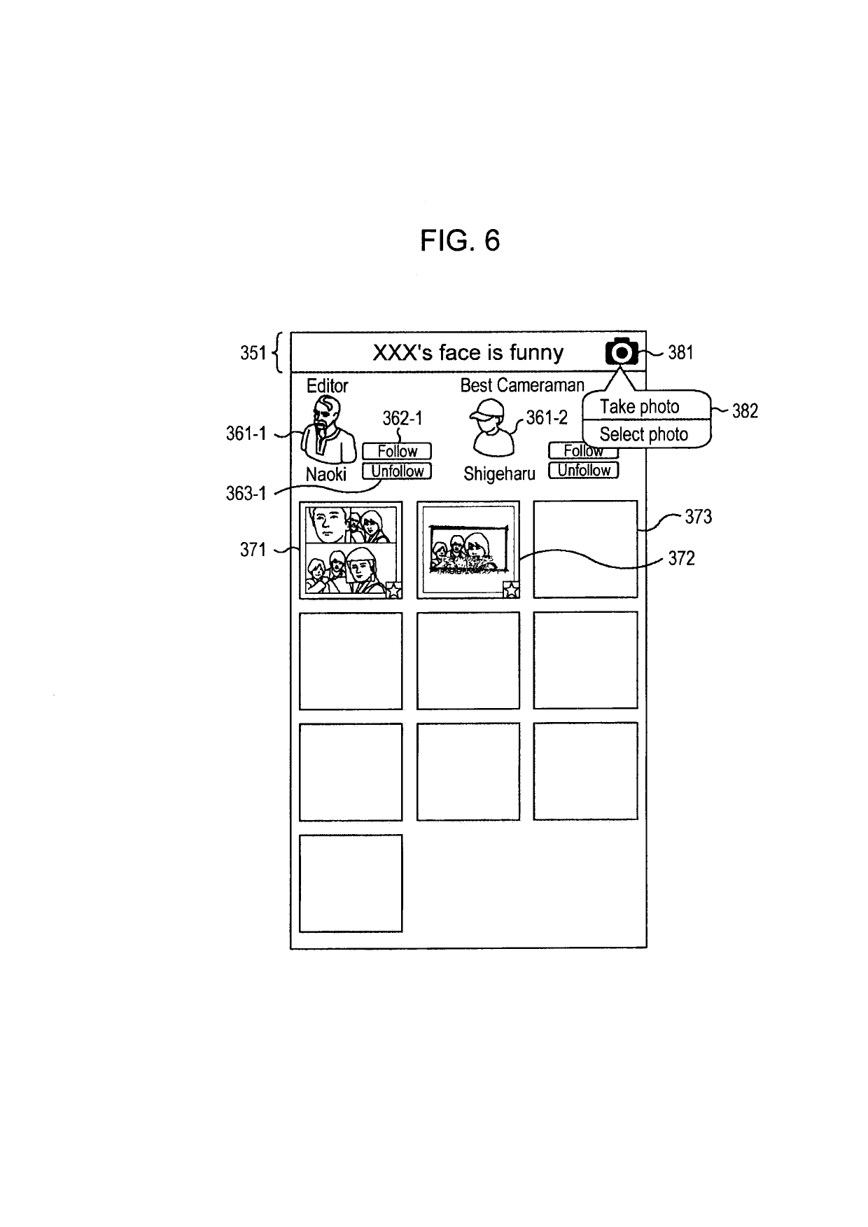

By pressing a button 381 located on a right edge of the title display section 351, the user can post an image in the thread. For example, in FIG. 5, when the button 381 has been clicked, a selection icon 382 having a balloon shape in which “take photo” and “select photo” are displayed has been displayed as illustrated in FIG. 6. If “take photo” is selected in the selection icon 382, an image is captured using the digital camera function of the terminal 21. If “select photo” is selected in the selection icon 382, selection of images stored in the storage unit 123 of the terminal 21 and the removable medium 126 begins.

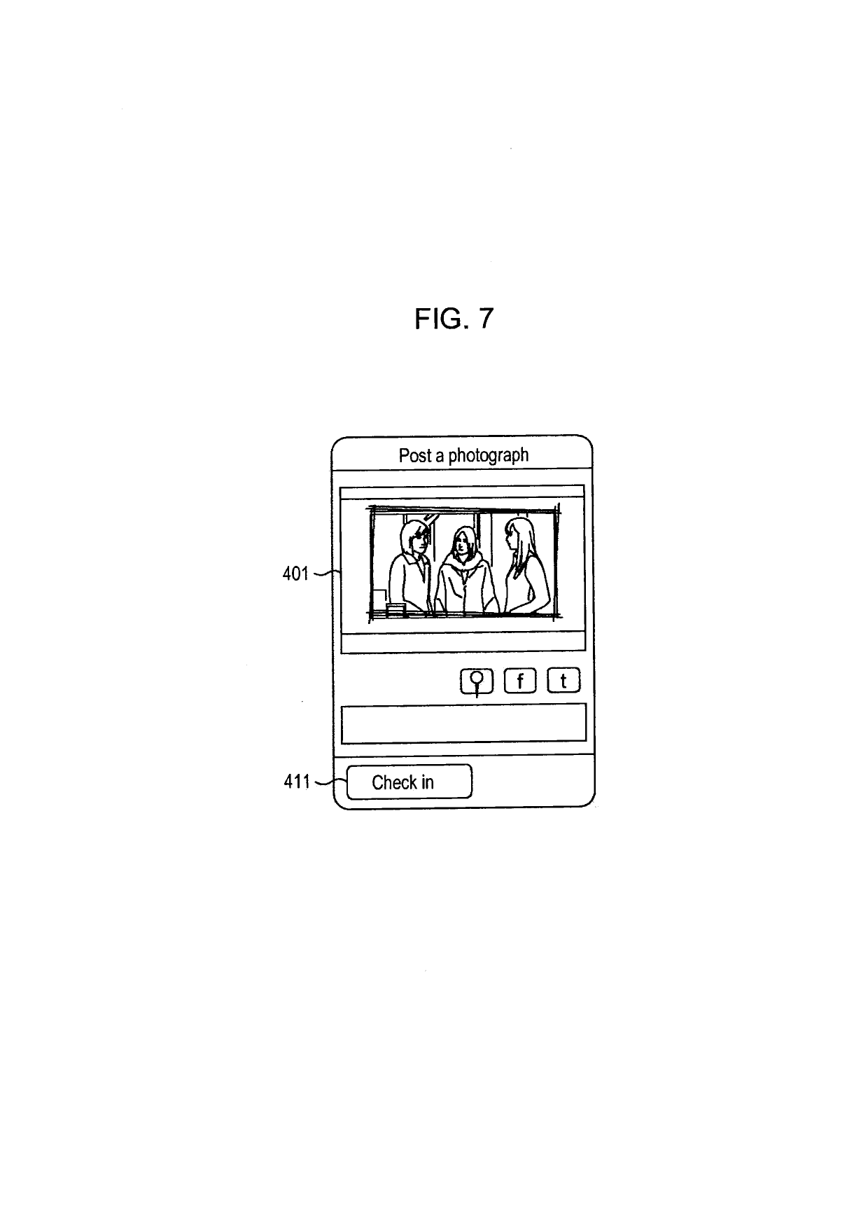

For example, if the user selects one of the images stored in the removable medium 126, a screen such as one illustrated in FIG. 7 is displayed on the display of the terminal 21. In FIG. 7, “post a photograph” is displayed in an upper portion of the screen, and an image 401 selected by the user is displayed in the center of the screen.

When the user has pressed a button 411 located in a lower portion of the screen, data regarding the image 401 is transmitted to the server 22 through the network. Thus, information stored in the database 26 of the server 22 is updated and the posting of the image in the thread is completed. For example, if the thread is selected after the image 401 has been posted, the image 401 is displayed on a region 373 illustrated in FIG. 6.

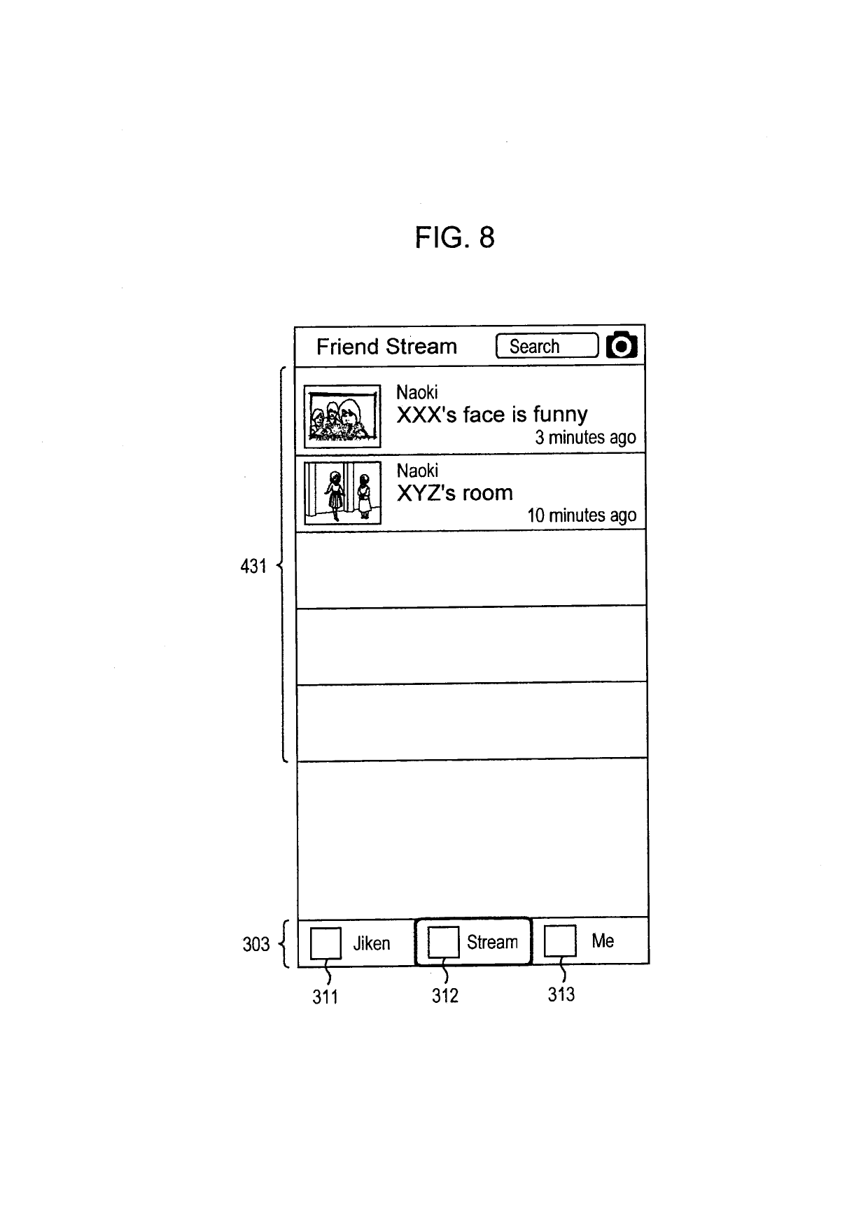

In FIG. 4, for example, when the display switching button 312 has been pressed, a screen such as one illustrated in FIG. 8 is displayed on the display of the terminal 21. FIG. 8 illustrates an example of a screen in which a list of threads created by a user registered to the “friend stream” or a list of threads in which the user registered to the “friend stream” has posted images is displayed. In the example illustrated in FIG. 8, the display switching button 312 has been selected in the display switching button display section 303.

As described above, by pressing the button 362-1 or 362-2 illustrated in FIG. 5, it is possible to register a certain user to the “friend stream”. Now, suppose that the user of the terminal 21 (for example, an owner of the terminal 21) has registered the user having the handle name “Naoki” to the “friend stream”. In a thread display section 431 illustrated in FIG. 8, the thread having the title “XXX's face is funny” and a thread having a title “XYZ's room” are displayed.

In FIG. 8, a thumbnail is displayed on the left of each title and the handle name (“Naoki”) of the user who has created each thread is displayed over each title. Information indicating the update time of each thread (“3 minutes ago”, “10 minutes ago”, or the like) is displayed under each title.

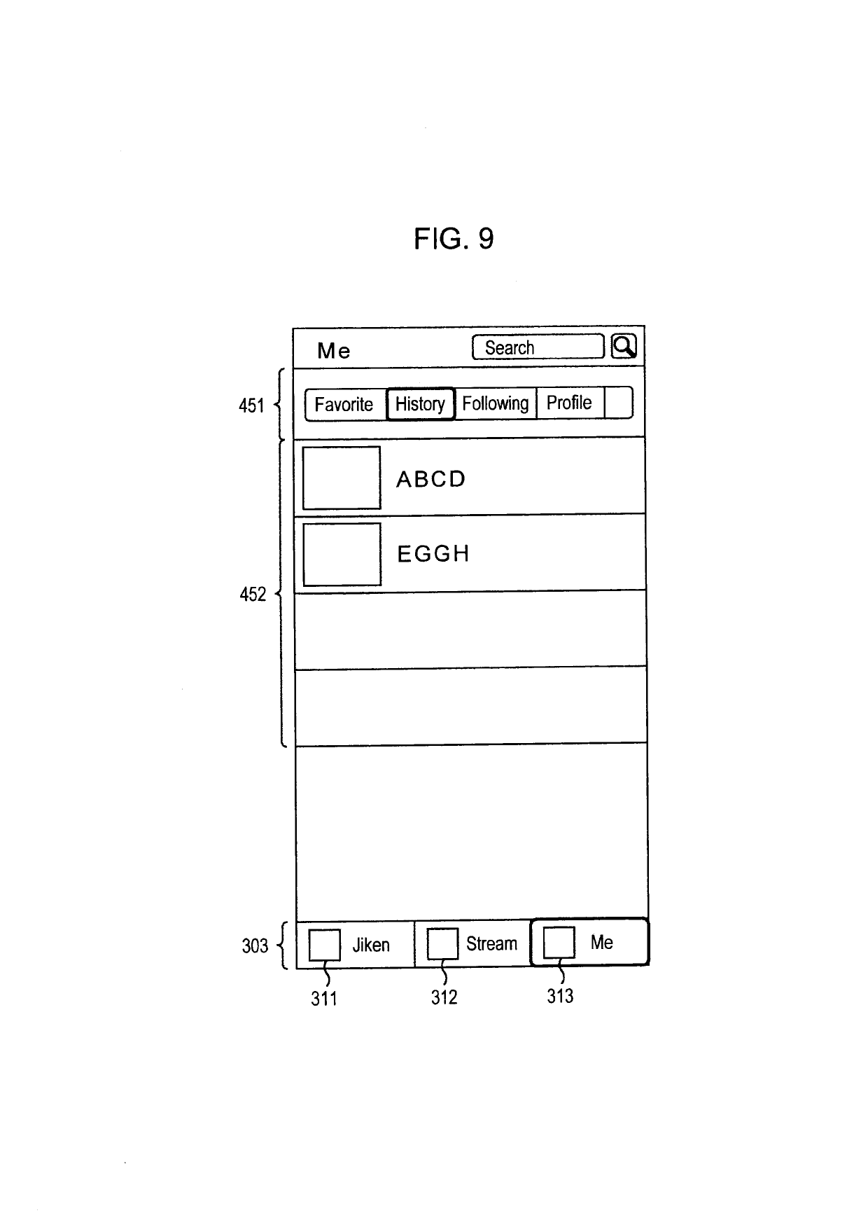

In FIG. 4, for example, when the display switching button 313 has been pressed, a screen such as one illustrated in FIG. 9 is displayed on the display of the terminal 21. FIG. 9 illustrates an example of a screen in which information relating to the history of the user of the terminal 21 is displayed. In the example illustrated in FIG. 9, the display switching button 313 has been selected in the display switching button display section 303.

Various buttons are displayed in a display information selection section 451 illustrated in FIG. 9. In the example illustrated in FIG. 9, because a “history” button has been selected in the display information selection section 451, threads created by the user of the terminal 21 are displayed in a thread display section 452.

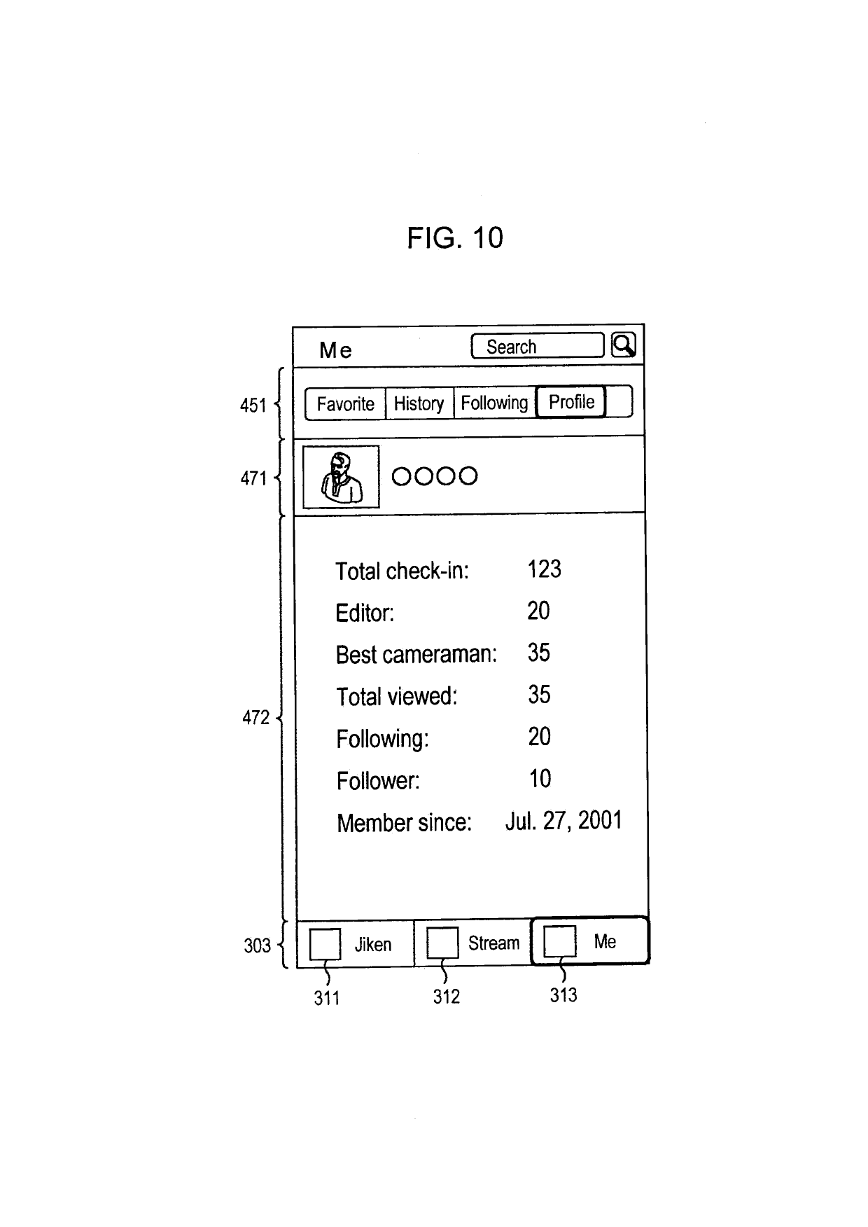

Furthermore, in FIG. 9, when a “profile” button has been selected in the display information selection section 451, a screen such as one illustrated in FIG. 10 is displayed on the display of the terminal 21. In the example illustrated in FIG. 10, since the “profile” button has been selected in the display information selection section 451, the user icon and the handle name (“0000” in this example) of the user of the terminal 21 are displayed in a user information display section 471.

In a user history display section 472, the total number of images the user has posted (“total check-in”), the total number of threads the user has created (“editor”), and the total number of threads in which the user is currently elected the “best cameraman” (“best cameraman”). Furthermore, in the user history display section 472, the total number of evaluations given to images the user has posted (“total viewed”), the total number of users the user has registered to the “friend stream” (“following”), and the total number of users who have registered the user to the “friend stream” (“follower”) are displayed. In the user history display section 472, information relating to the date and time when the user has been registered to the SNS as a member (“member since”) is also displayed.

In the present technology, a posted image can be evaluated by attaching a certain mark to the image.

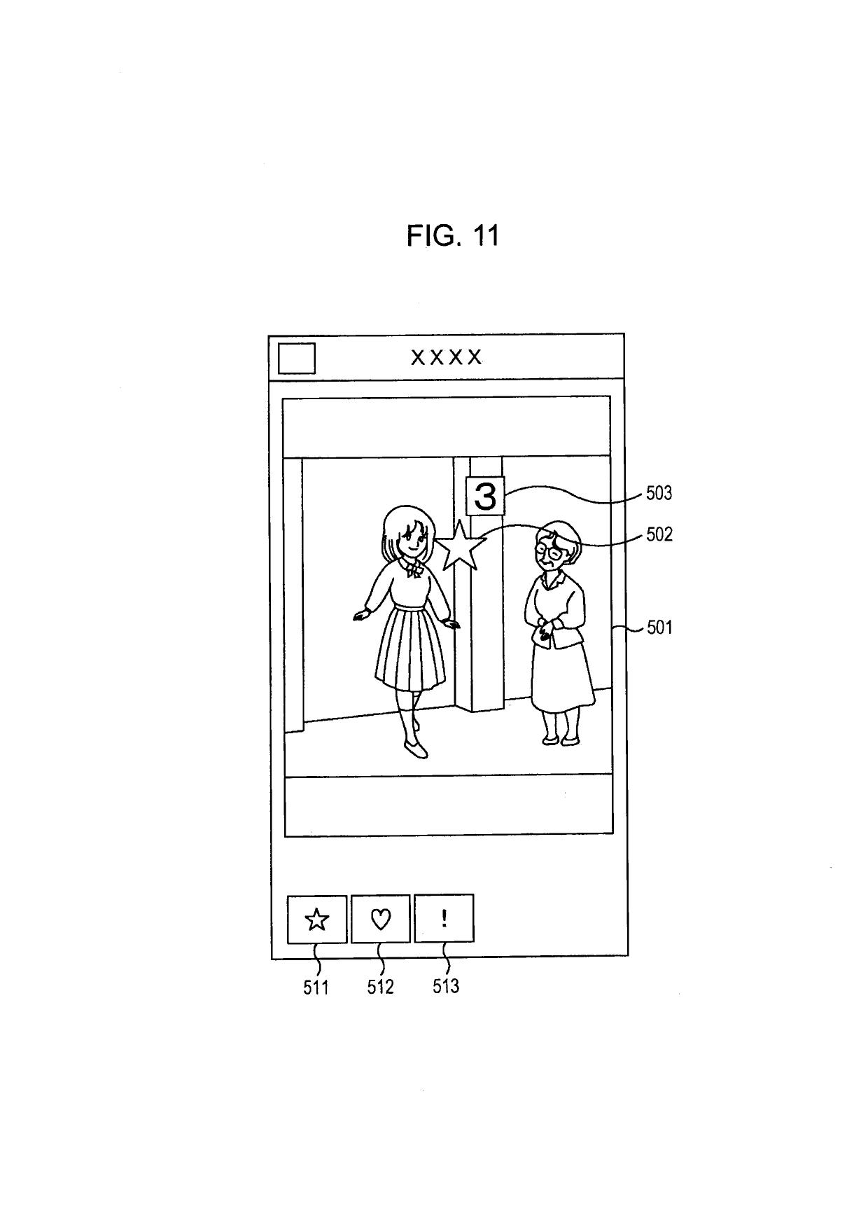

For example, when a desired image in a list of posted images displayed in the screen illustrated in FIG. 5 has been clicked, the image is enlarged. FIG. 11 illustrates an example of a certain image displayed on the display of the terminal 21 when the image has been clicked in the list of the posted images.

A clicked image 501 has been enlarged and is displayed in the center of the screen illustrated in FIG. 11. For example, the handle name of a user who has posted the image is displayed over the image 501 (here, the handle name of the user is represented as “XXXX”).

Marks 511 to 513 for evaluation are displayed in a lower portion of the screen illustrated in FIG. 11. The marks 511 to 513 are, for example, configured as GUI components and can be dragged and dropped. For example, the user can drag the mark 511 and drop the mark 511 at an arbitrary position in the image 501. That is, the user can attach a desired mark for evaluation to an arbitrary position in an image to be evaluated.

Each of the marks 511 to 513 is, for example, associated with a meaning of evaluation in advance. For example, the mark 511 is meant to indicate that the user thinks something is beautiful, the mark 512 is meant to indicate that the user thinks something looks familiar, and the mark 513 is meant to indicate that the user is surprised by something.

For example, in the screen illustrated in FIG. 11, the user drops the mark 511 at a portion that the user thinks beautiful. As a result, an image 502 of the mark 511 is superimposed upon the image 501 and a countdown indicator 503 is displayed close to the image 502. The countdown indicator 503 indicates, for example, the time (for example, seconds) that elapses before the attachment of a mark is determined. In this example, the countdown indicator 503 indicates “3”.

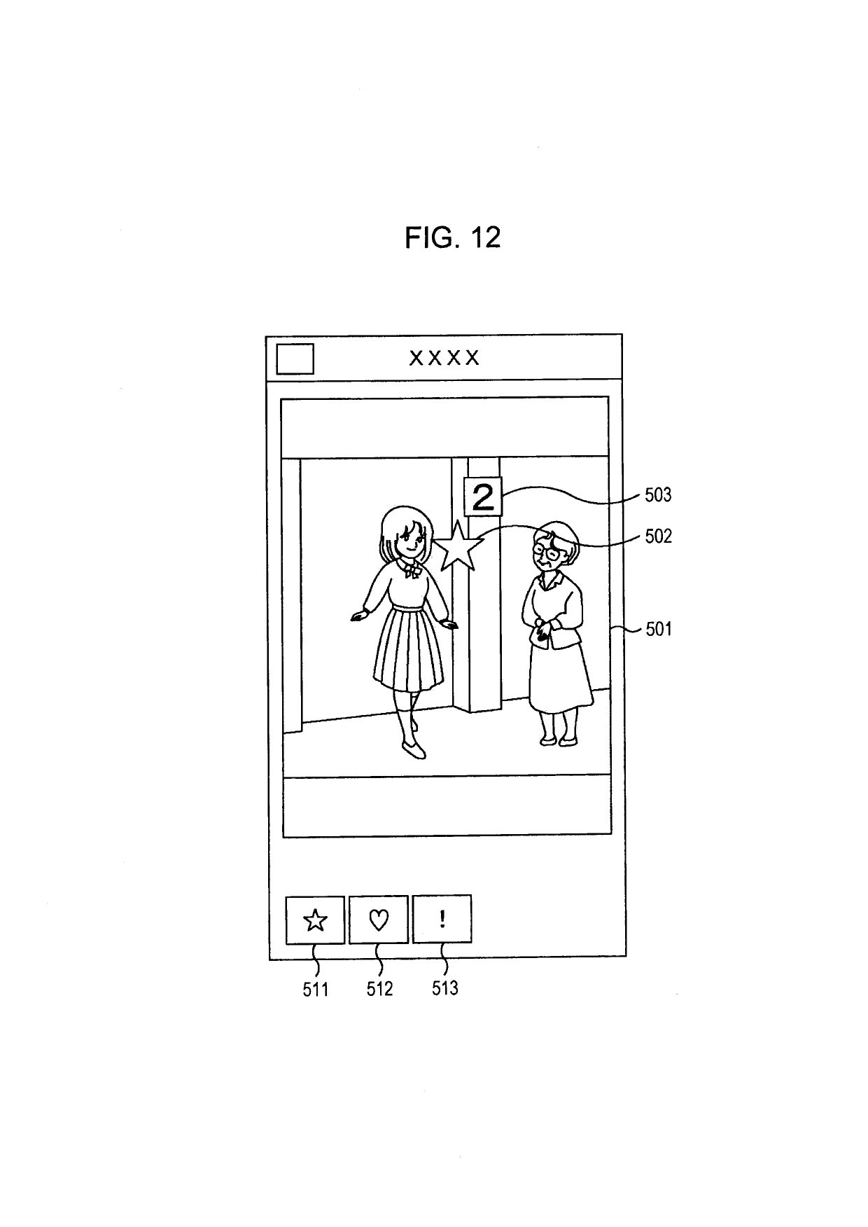

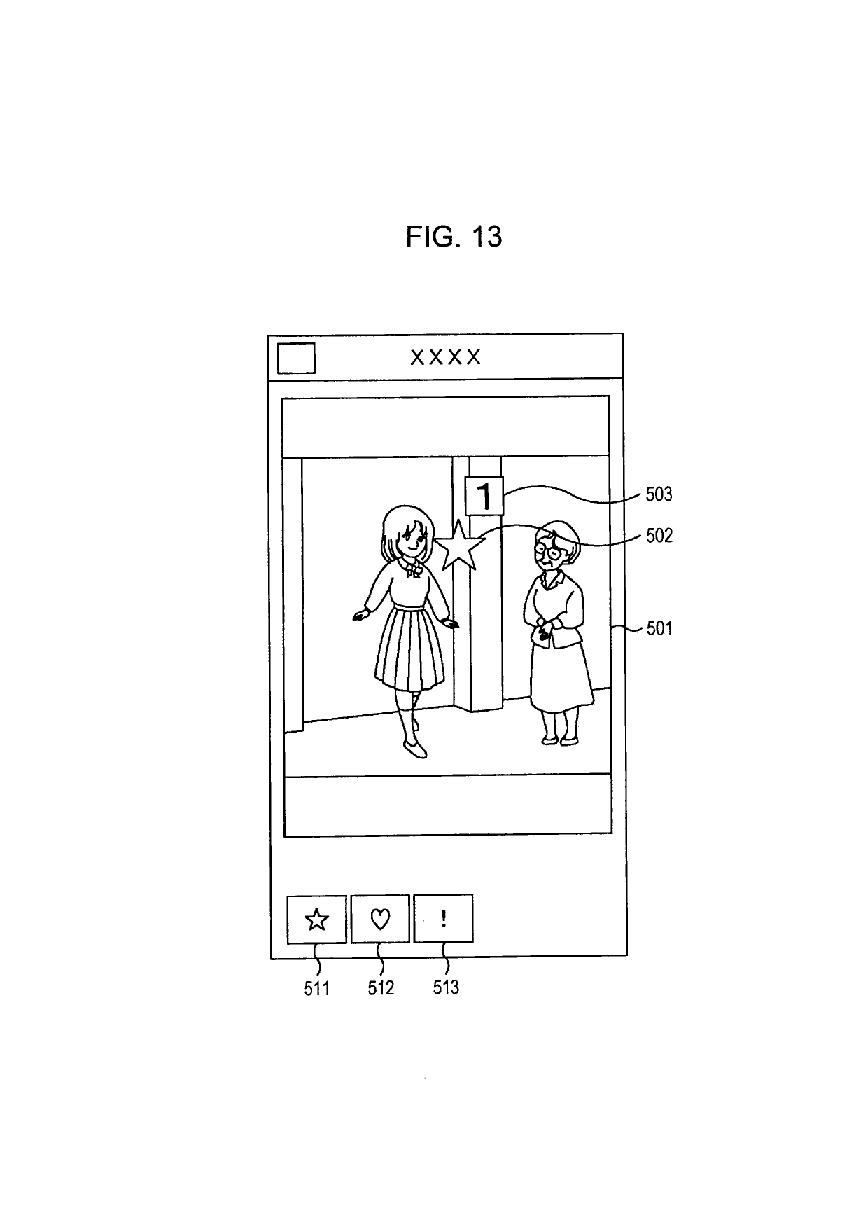

After the mark 511 is dropped, the countdown indicator 503 continues countdown unless the mark 511 is moved or any particular operation is performed. For example, as illustrated in FIG. 12, the countdown indicator 503 indicates “2”, and, as illustrated in FIG. 13, then indicates “1”.

That is, for example, when the mark 511 has not been moved for one second while the screen illustrated in FIG. 11 is displayed, the indication of the countdown indicator 503 changes to “2” as illustrated in FIG. 12. Furthermore, for example, when the mark 511 has not been moved for one second while the screen illustrated in FIG. 12 is displayed, the indication of the countdown indicator 503 changes to “1” as illustrated in FIG. 13. Thereafter, for example, when the mark 511 has not been moved for one second while the screen illustrated in FIG. 13 is displayed, the countdown ends.

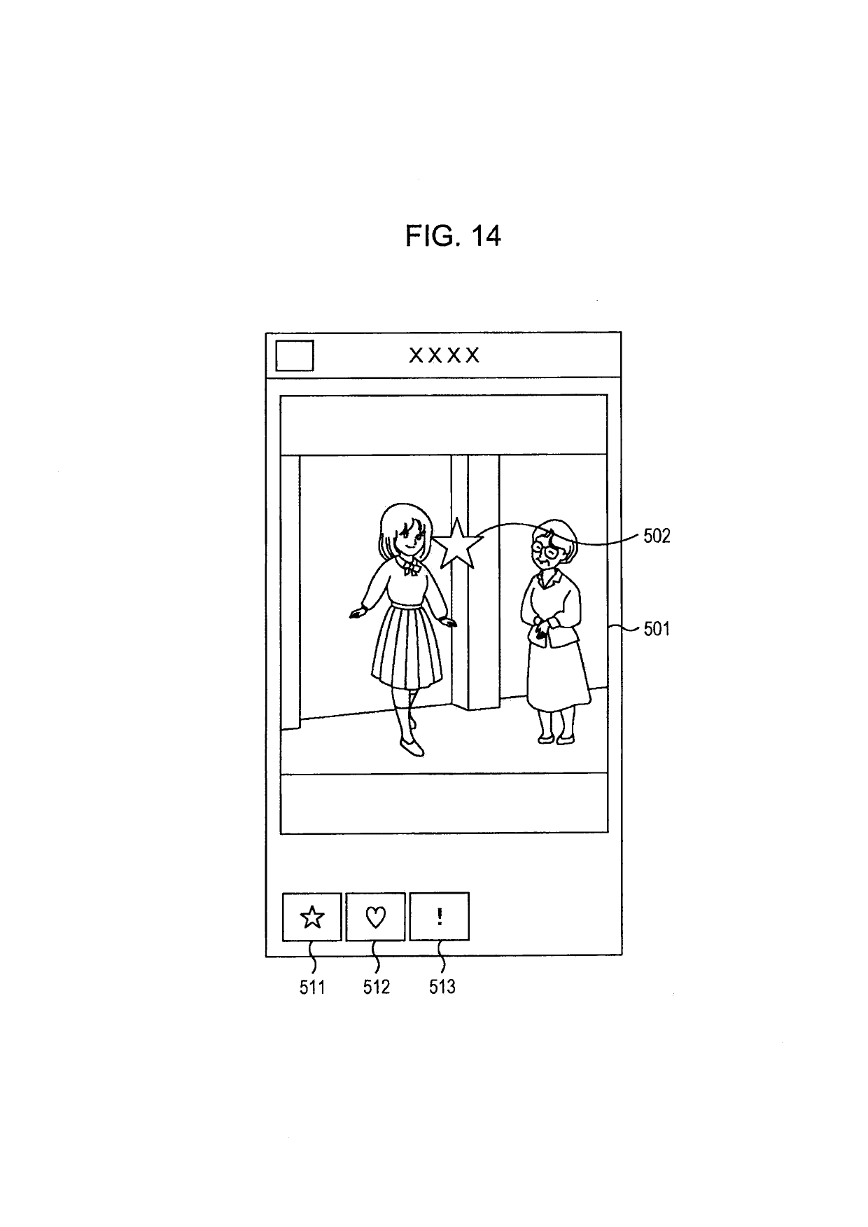

When the countdown has ended, the indication of the countdown indicator 503 is deleted and, for example, the image 502 is displayed as illustrated in FIG. 14. Thus, the attachment of the mark 511 is determined.

At this time, the terminal 21 is configured to transmit, for example, identification information indicating the mark 511, positional information (for example, coordinates) indicating the position to which the mark 511 has been attached, and the handle name of the user who has attached the mark 511 to the server 22 as information relating the evaluation of the image 501.

In order to make it possible for the user to sense (have feedback) that the information relating to the evaluation of the image 501 has been transmitted to the server 22, the terminal 21 displays the image 501 such that the image 501 vibrates for a certain period of time (for example, 0.5 second). For example, if the terminal 21 has a vibration function, the terminal 21 itself may vibrate, instead. In addition, for example, methods other than the above-described methods may be used insofar as the user is provided with any kind of feedback as to the transmission of the information relating to the evaluation of the image 501 to the server 22.

The information relating to the evaluation of the image 501 transmitted from the terminal 21 in the above-described manner is received by the server 22 and then associated with the corresponding thread and the image 501 and stored in the database 26. The server 22 is configured to store, in the database 26, information regarding the date and time when the server 22 has received the information relating to the evaluation of the image 501, too. That is, it is possible to identify who has evaluated a posted image, when the posted image has been evaluated, which portion of the posted image has been evaluated, and how the posted image has been evaluated, on the basis of the information stored in the database 26 of the server 22.

An image to which a mark has been attached in the above-described manner can be displayed on a terminal of another user such that the mark is superimposed upon the image. For example, when the image 501 has been enlarged and displayed on the terminal 21-2 after the mark 511 is attached to the image 501 by the terminal 21-1, the image 502 of the mark 511 is superimposed upon the image 501 at a position to which the user of the terminal 21-1 has attached the mark 511.

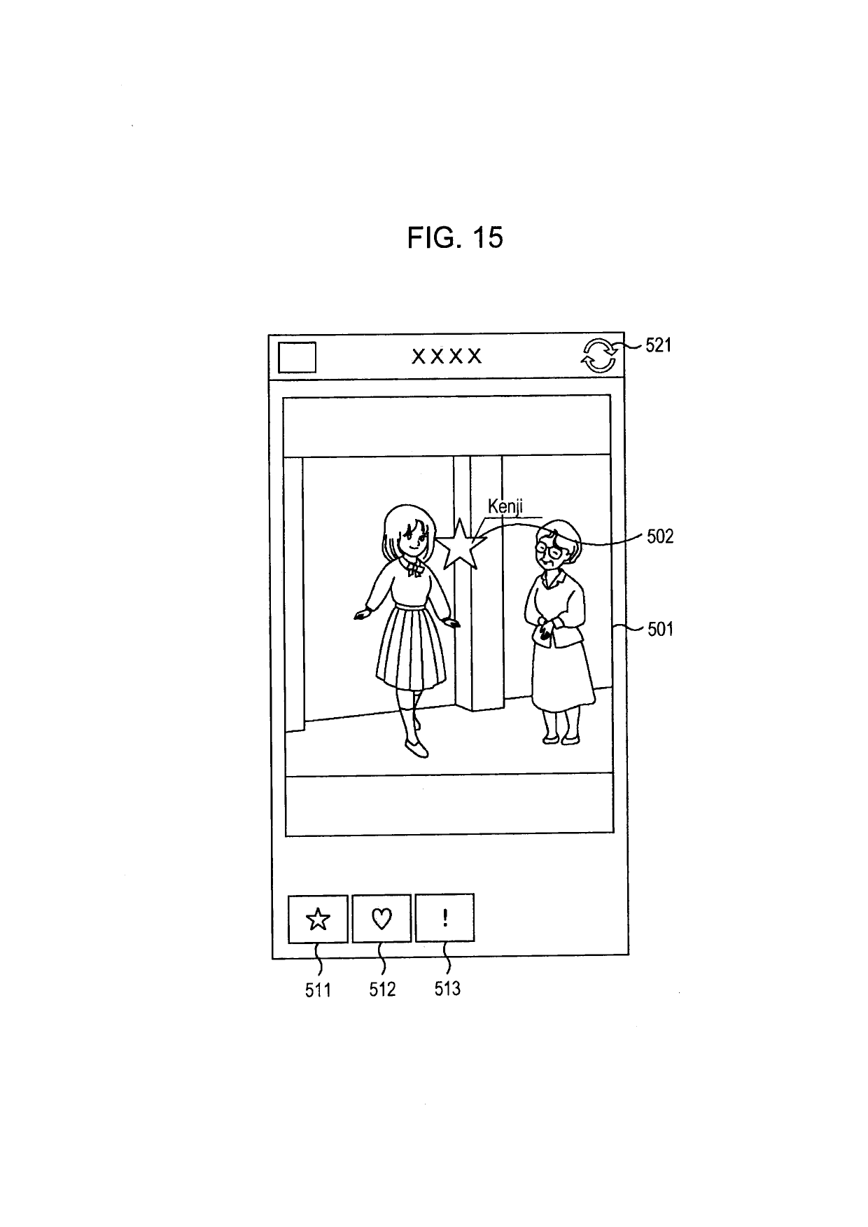

At this time, for example, a screen such as one illustrated in FIG. 15 is displayed on a display of the terminal 21-2. In the terminal 21-2, for example, a screen such as that illustrated in FIG. 15 is displayed by selecting, in a screen such as that illustrated in FIG. 4, a thread in which the image 501 has been posted and by clicking the image 501 in a screen such as that illustrated in FIG. 5.

In the screen illustrated in FIG. 15, the image 502 of the mark 511 is displayed on the upper-right of the center of the image 501, which is the same position as that at which the image 502 of the mark 511 is displayed in FIG. 14. In the screen illustrated in FIG. 15, the handle name (“Kenji”) of the user of the terminal 21-1 is displayed close to the image 502.

That is, since the information relating to the evaluation of the image 501 has also been downloaded when the image 501 has been downloaded from the server 22 to the terminal 21-2, a screen such as that illustrated in FIG. 15 can be displayed. In other words, it is possible for the terminal 21-2 to identify which part of the image 501 the user of the terminal 21-1 has attached a mark to and which mark the user has attached, on the basis of the information relating to the evaluation of the image 501. Thus, the image 502 of the mark 511 is superimposed upon the image 501 at a position to which the user of the terminal 21-1 has attached the mark 511 and the handle name of the user of the terminal 21-1 is displayed together with the image 502.

A configuration may also be used in which the handle name of the user is not displayed.

In the screen illustrated in FIG. 15, the image 502 and the handle name of the user of the terminal 21-1 are configured to be automatically deleted when the image 502 and the handle name have been displayed for a certain period of time (for example, 1 second). For example, in the case of an image to which a lot of marks have been attached, it is difficult to see the image if all the marks are superimposed upon the image. For this reason, a mark that has been displayed for the certain period of time is automatically deleted.

In addition, in the case of an image to which a lot of marks have been attached, for example, a mark that has been attached later (or earlier) is displayed and deleted earlier. As described above, the server 22 is configured to store, in the database 26, the information relating to the evaluation of the image 501 together with the information regarding the date and time when the information relating to the evaluation of the image 501 has been received. For example, by referring to the information regarding the date and time when the information relating to the evaluation of the image 501 included in the information relating to the evaluation of the image 501 downloaded from the server 22, the terminal 21-2 can identify the order in which the marks have been attached. Therefore, in a screen displayed on the display of the terminal 21-2, for example, it is possible to display a mark that has been attached later (or earlier) earlier and delete the mark that has been attached later (or earlier) earlier.

Furthermore, for example, by pressing a reload button 521 displayed on an upper-right portion of the screen illustrated in FIG. 15, the marks attached to the screen can be sequentially displayed again. For example, suppose that, at this time, the reload button 521 has been pressed while the image 501 is displayed on the terminal 21-2 and a user of the terminal 21-3 has newly attached the mark 512 to the center of the right side of the image 501 several seconds before the reload button 521 is pressed. In this case, for example, when the reload button 521 has been pressed, the image of the mark 512 is superimposed upon the image 501 at the center of the right side of the image 501 and the image 502 of the mark 511 is superimposed upon the image 501 on the upper-right of the center of the image 501.

When the image of the mark 512 has been displayed for a certain period of time, the image of the mark 512 is deleted, and when the image 502 of the mark 511 has been displayed for a certain period of time, the image 502 of the mark 511 is deleted.

That is, for example, if the reload button 521 is pressed in the screen illustrated in FIG. 15, the information relating to the evaluation of the image 501 is downloaded from the server 22 again.

Alternatively, for example, in the screen illustrated in FIG. 15, a button for displaying all the marks attached to the image 501 at once (in this case, the marks are not automatically deleted even after the elapse of a certain period of time) or a button for deleting all the displayed marks may be provided.

That is, for example, when a certain button for displaying marks provided within the screen illustrated in FIG. 15 has been pressed, all the marks attached to the image 501 may be displayed at once. In addition, for example, when a certain button for deleting marks provided within the screen illustrated in FIG. 15 has been pressed, all the marks for evaluation that have been displayed may be deleted at once.

Thus, the content posted by the user is evaluated in the SNS realized by the information processing system 10.

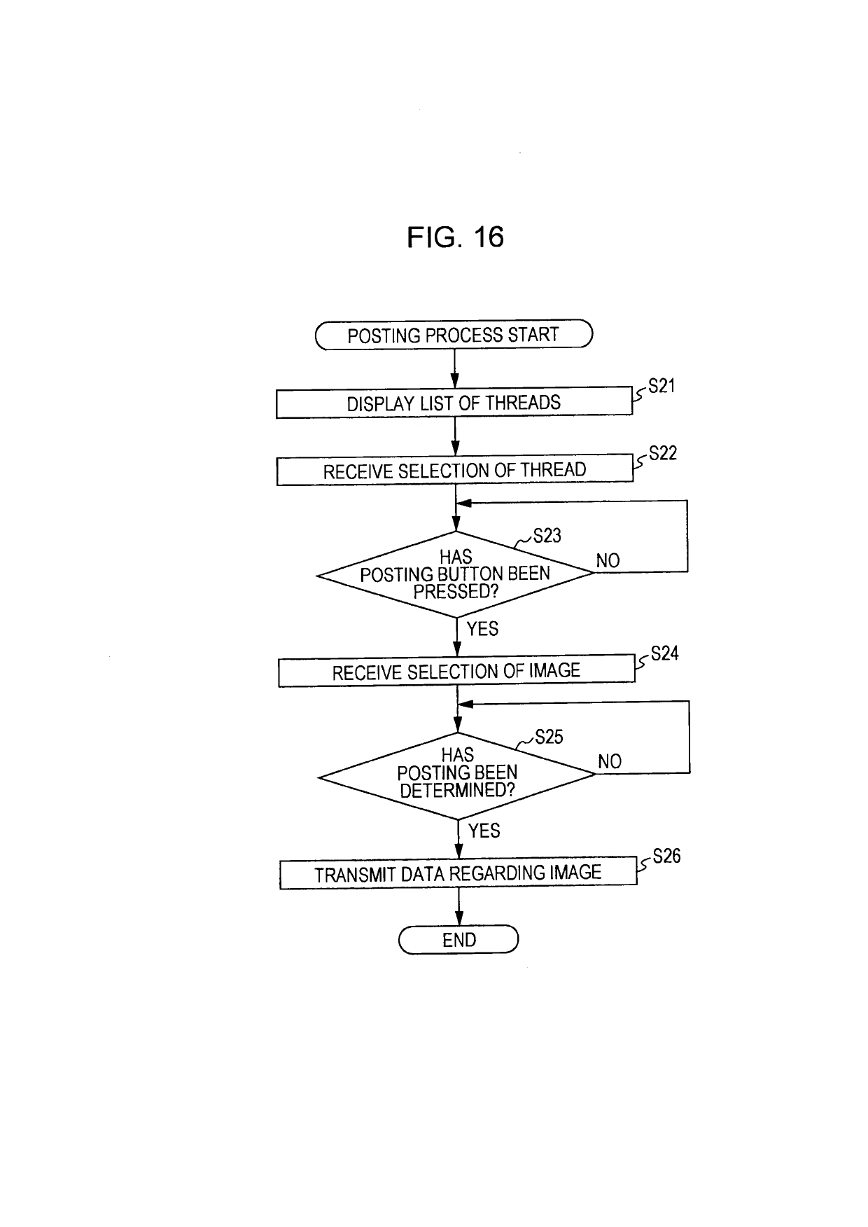

Next, an example of a process for posting content such as an image executed by the terminal 21 will be described with reference to a flowchart of FIG. 16. This process is executed, for example, when the terminal 21 has accessed the server 22 through the network and logged in the account of the SNS.

In step S21, the CPU 111 of the terminal 21 displays a list of threads. At this time, a screen such as that illustrated in FIG. 4, 8 or 9 is displayed on the display of the terminal 21 and the list of threads is displayed in the thread display section of the screen.

In step S22, the CPU 111 receives selection of a thread performed by the user. Thus, for example, a screen such as that illustrated in FIG. 5 is displayed on the display of the terminal 21.

In step S23, the CPU 111 judges whether or not a button for posting has been pressed, and waits until it is judged that the button for posting has been pressed. At this time, for example, whether or not the button 381 illustrated in FIG. 5 has been clicked (pressed) is judged.

In step S23, if the button for posting has been pressed, the process proceeds to step S24.

In step S24, the CPU 111 receives selection of an image to be posted. At this time, for example, as described above with reference to FIG. 6, an image to be posted is selected from among images captured by using the digital camera function or images stored in the storage unit 123, the removable medium 126, and the like.

In step S25, the CPU 111 judges whether or not posting has been determined, and waits until it is judged that posting has been determined. For example, when the button 411 located in a lower portion of the screen illustrated in FIG. 7 has been pressed, it is judged that posting has been determined.

If it is judged in step S25 that posting has been determined, the process proceeds to step S26.

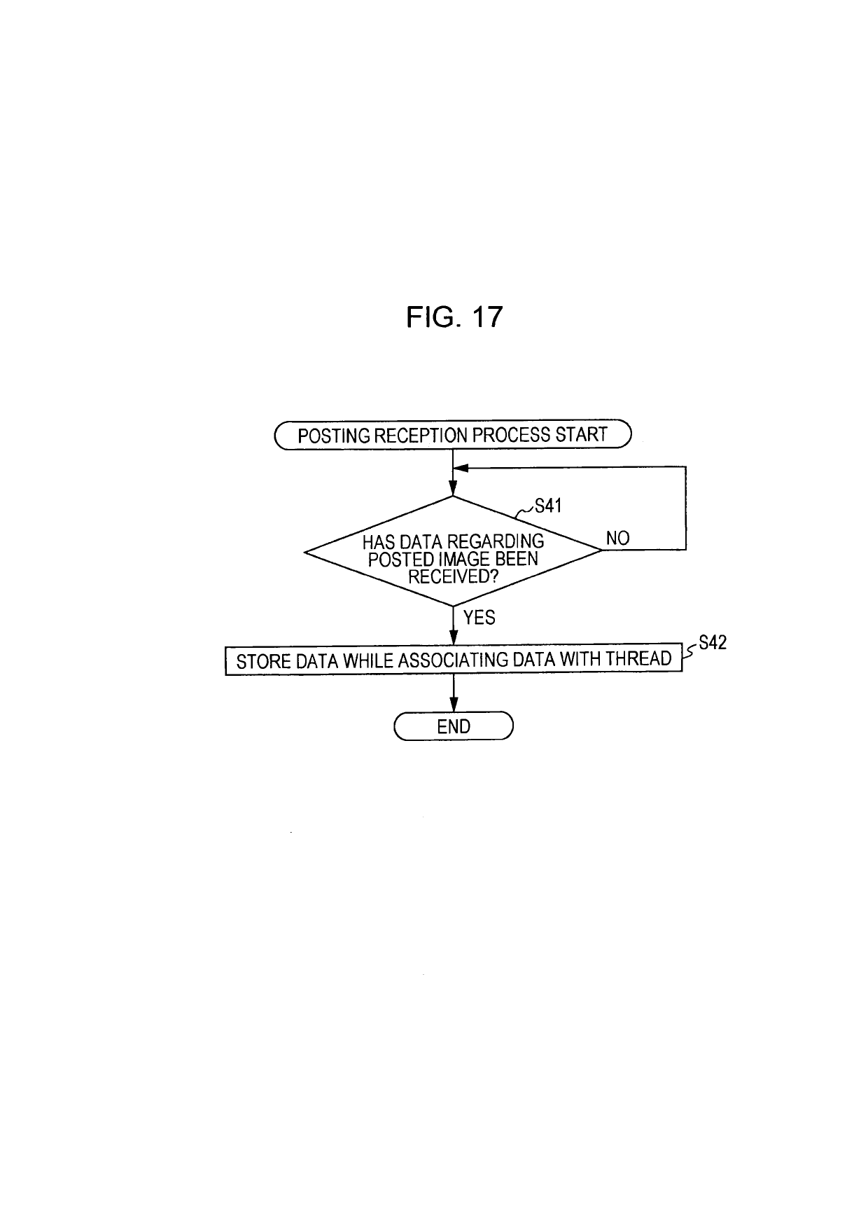

In step S26, the CPU 111 transmits data regarding the image selected in step S24. Thus, for example, the data regarding the image 401 illustrated in FIG. 7 is transmitted to the server 22 through the network. By a process that will be described later with reference to FIG. 17, information stored in the database 26 of the server 22 is updated and the posting of the image 401 in the thread is completed. If, for example, the thread is selected after the completion of the posting of the image 401, the image 401 is displayed in the region 373 illustrated in FIG. 6.

The posting process is thus executed.

Next, an example of a process for receiving posting executed by the server 22 in accordance with the posting process illustrated in FIG. 16 will be described with reference to a flowchart of FIG. 17.

In step S41, the CPU 201 of the server 22 judges whether or not data regarding a posted image has been received. At this time, for example, whether or not data regarding an image transmitted by the terminal 21 in the processing executed in step S26 illustrated in FIG. 16 has been received through the network is judged.

In step S42, the CPU 201 stores the data regarding the posted image that has been judged to have been received in the processing executed in step S41 while associating the data with a thread. It is to be noted that the data regarding the image transmitted by the terminal 21 in the processing executed in step S26 includes, for example, information regarding the handle name of a user who has posted the image and the like. The CPU 201 also stores the handle name, the time when the data has been received, and the like together with the data regarding the image. Thus, information stored in the database 26 has been updated and the posting of the image in the thread has been completed.

The process for receiving posting is thus executed.

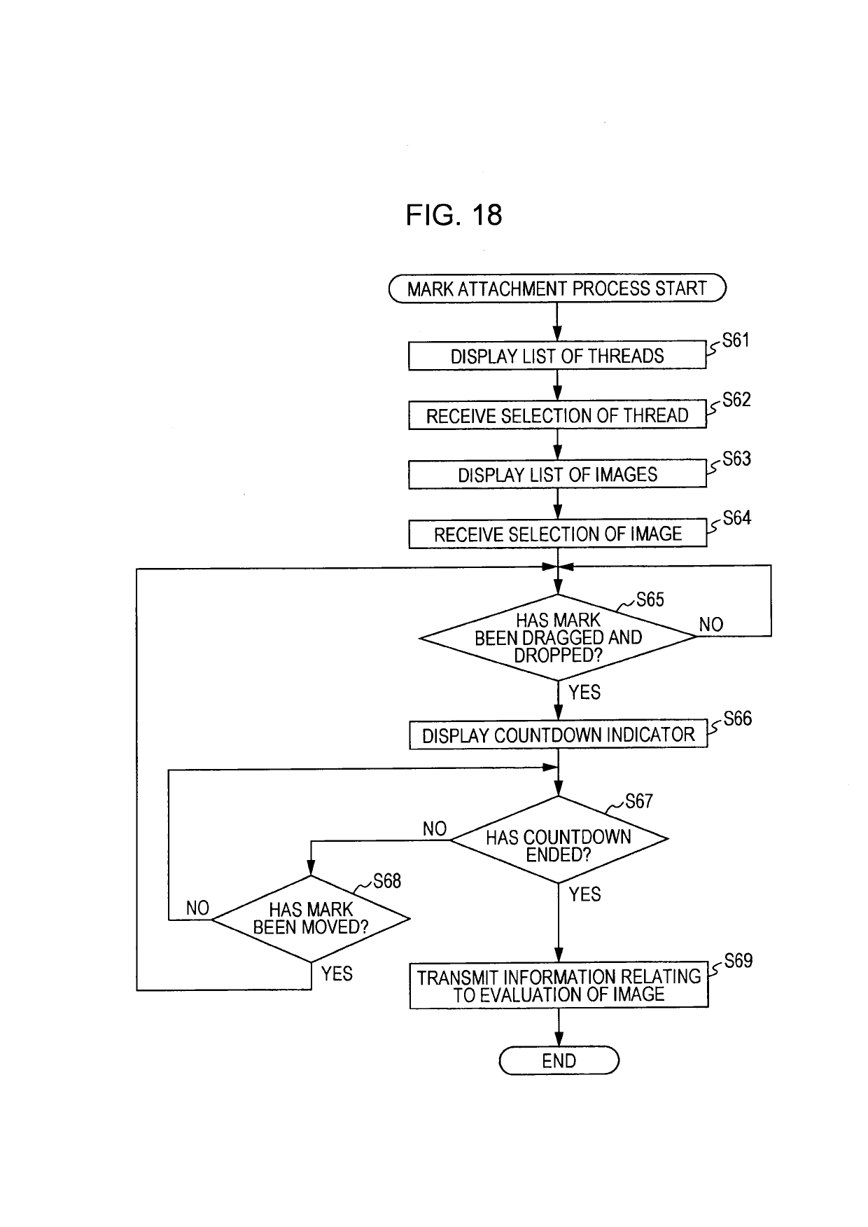

Next, an example of a process for attaching a mark executed by the terminal 21 will be described with reference to a flowchart of FIG. 18. This process is executed, for example, when the terminal 21 has accessed the server 22 through the network and logged in the account of the SNS.

In step S61, the CPU 111 of the terminal 21 displays a list of threads. At this time, for example, a screen such as that illustrated in FIG. 4, 8, or 9 is displayed on the display of the terminal 21, and the list of threads is displayed in the thread display section of the screen.

In step S62, the CPU 111 receives selection of a thread performed by the user.

In step S63, the CPU 111 displays a list of images. At this time, for example, a screen such as that illustrated in FIG. 5 is displayed on the display of the terminal 21.

In step S64, the CPU 111 receives selection of an image. For example, when a desired image in the list of posted images displayed in the screen illustrated in FIG. 5 has been clicked, the image is selected.

For example, when a desired image in the list of posted images displayed in the screen illustrated in FIG. 5 has been clicked, the image is enlarged. That is, a screen such as that illustrated in FIG. 11 is displayed on the display of the terminal 21.

In step S65, the CPU 111 judges whether or not a mark has been dragged and dropped, and waits until it is judged that a mark has been dragged and dropped.

As described above with reference to FIG. 11, the marks 511 to 513 for evaluation are displayed in the screen. The marks 511 to 513 are, for example, configured as GUI components and can be dragged and dropped. For example, the user can drag the mark 511 and drop the mark 511 at an arbitrary position in the image 501.

If it is judged in step S65 that a mark has been dragged and dropped, the process proceeds to step S66.

In step S66, the CPU 111 displays a countdown indicator. At this time, for example, in the screen illustrated in FIG. 11, the image 502 of the mark 511 is superimposed upon the image 501 and the countdown indicator 503 is displayed close to the image 502.

In step S67, the CPU 111 judges whether or not countdown has been completed. If it is judged that countdown has not been completed, the process proceeds to step S68.

In step S68, the CPU 111 judges whether or not the mark has been moved. If it is judged in step S68 that the mark has been moved, the process returns to step S65. On the other hand, if it is judged that the mark has not been moved, the process returns to step S67.

As described above, after the mark 511 has been dropped, the countdown indicator 503 continues the countdown unless the mark 511 is moved or any particular operation is performed. That is, as illustrated in FIG. 12, the countdown indicator 503 indicates “2” and, as illustrated in FIG. 13, then indicates “1”.

If it is judged in step S67 that countdown has been completed, the process proceeds to step S69.

In step S69, the CPU 111 transmits information relating to evaluation of the image selected in step S64.

At this time, for example, identification information indicating the mark 511 illustrated in FIG. 14, positional information (for example, coordinates) indicating the position to which the mark 511 has been attached, and the handle name of the user who has attached the mark 511 are transmitted to the server 22 as the information relating the evaluation of the image 501.

Furthermore, at this time, in order to make it possible for the user to sense (have feedback) that the information relating to the evaluation of the image 501 has been transmitted to the server 22, the terminal 21 displays the image 501 such that the image 501 vibrates for a certain period of time (for example, 0.5 second). For example, if the terminal 21 has the vibration function, the terminal 21 itself may vibrate, instead.

The process for attaching a mark is thus executed.

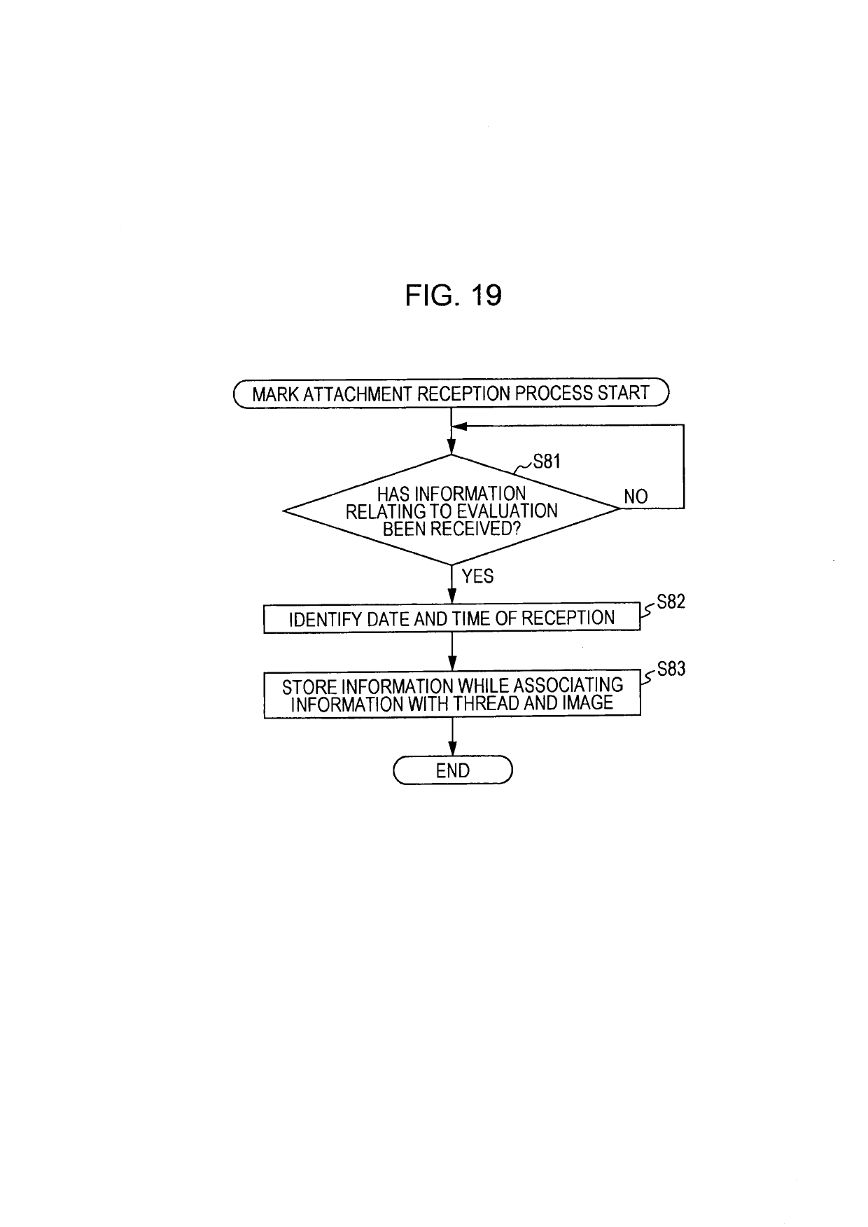

Next, an example of a process for receiving attachment of a mark executed by the server 22 in accordance with the process for attaching the mark illustrated in FIG. 18 will be described with reference to a flowchart of FIG. 19.

In step S81, the CPU 201 of the server 22 judges whether or not information relating to evaluation has been received. At this time, for example, whether or not the information relating to the evaluation transmitted by the terminal 21 in the processing executed in step S69 illustrated in FIG. 18 has been received through the network is judged.

In step S82, the CPU 201 identifies the time when the information has been received, which has been obtained as a result of the judgment made in step S81, as the date and time of the reception.

In step S83, the CPU 201 adds the date and time of the reception identified in the processing executed in step S82 to the information relating to the evaluation that has been judged to have been received in the processing executed in step S81, and stores the date and time of the reception and the information relating to the evaluation in the database 26 while associating the date and time of the reception and the information relating to the evaluation with the thread and the image.

The process for receiving attachment of a mark is thus executed.

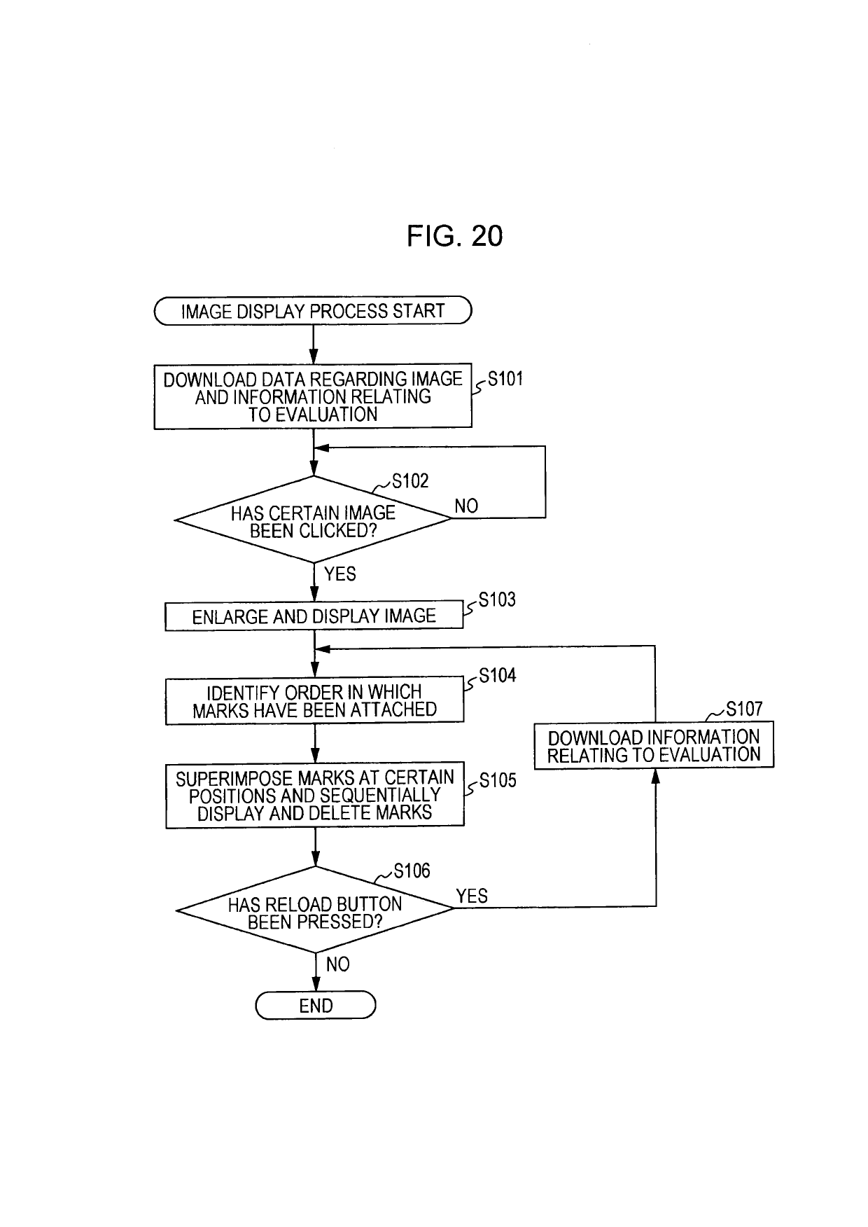

Next, an example of a process for displaying an image executed by the terminal 21 will be described with reference to a flowchart of FIG. 20. This process is executed, for example, when the terminal 21 has accessed the server 22 through the network and logged in the account of the SNS.

In step S101, the CPU 111 of the terminal 21 downloads data regarding an image posted in a certain thread and information relating to evaluation of the image from the server 22. For example, when a screen such as that illustrated in FIG. 5 is to be displayed on the terminal 21, data regarding an image and information relating to evaluation of the image are downloaded. For example, if a plurality of images (images posted in the corresponding thread) are included in a screen such as that illustrated in FIG. 5, data regarding the plurality of images and information relating to evaluation of the plurality of images are downloaded.

In step S102, the CPU 111 judges whether or not a certain image has been clicked, and waits until it is judged that a certain image has been clicked.

In step S103, the CPU 111 enlarges and displays the image that has been judged in step S102 to have been clicked. As described above, for example, if a desired image in a list of posted images displayed in the screen illustrated in FIG. 5 is clicked, the image is enlarged and displayed.

In step S104, the CPU 111 identifies the order in which marks have been attached. The information relating to the evaluation downloaded in the processing executed in step S101 includes the date and time of reception by the server 22. In the processing executed in step S104, the order (chronological order) in which the marks have been attached is identified on the basis of the date and time of reception of the information relating to the evaluation.

In step S105, the CPU 111 superimposes the marks upon the image and sequentially displays and deletes the marks on the basis of the information relating to the evaluation downloaded in the processing executed in step S101.

At this time, for example, as described above with reference to FIG. 15, the image 502 of the mark 511 and the handle name of the user of the terminal 21-1 are displayed for a certain period of time (for example, 1 second) and then automatically deleted. In the case of an image to which a lot of marks have been attached, for example, a mark that has been attached later (earlier) is displayed and deleted earlier.

In step S106, the CPU 111 judges whether or not the reload button has been pressed. If it is judged in step S106 that the reload button has been pressed, the process proceeds to step S107.

In step S107, the CPU 111 downloads the information relating to the evaluation of the image that has been enlarged and displayed in step S103 from the server 22. The process then returns to step S104.

For example, by pressing the reload button 521 displayed in an upper-right portion of the screen illustrated in FIG. 15, the marks attached to the image can be sequentially displayed again. For example, suppose that, at this time, the image 501 has been displayed and the reload button 521 has been pressed in the terminal 21-2, and the user of the terminal 21-3 has newly attached the mark 512 to the center of the right side of the image 501 several seconds before the reload button 521 is pressed. In this case, for example, the image of the mark 512 is superimposed upon the image 501 at the center of the right side of the image 501 after the reload button 521 is pressed, and then the image 502 of the mark 511 is superimposed upon the image 501 on the upper-right of the center of the image 501.

On the other hand, if it is judged in step S106 that the reload button has not been pressed, the process ends.

The process for displaying an image is thus executed.

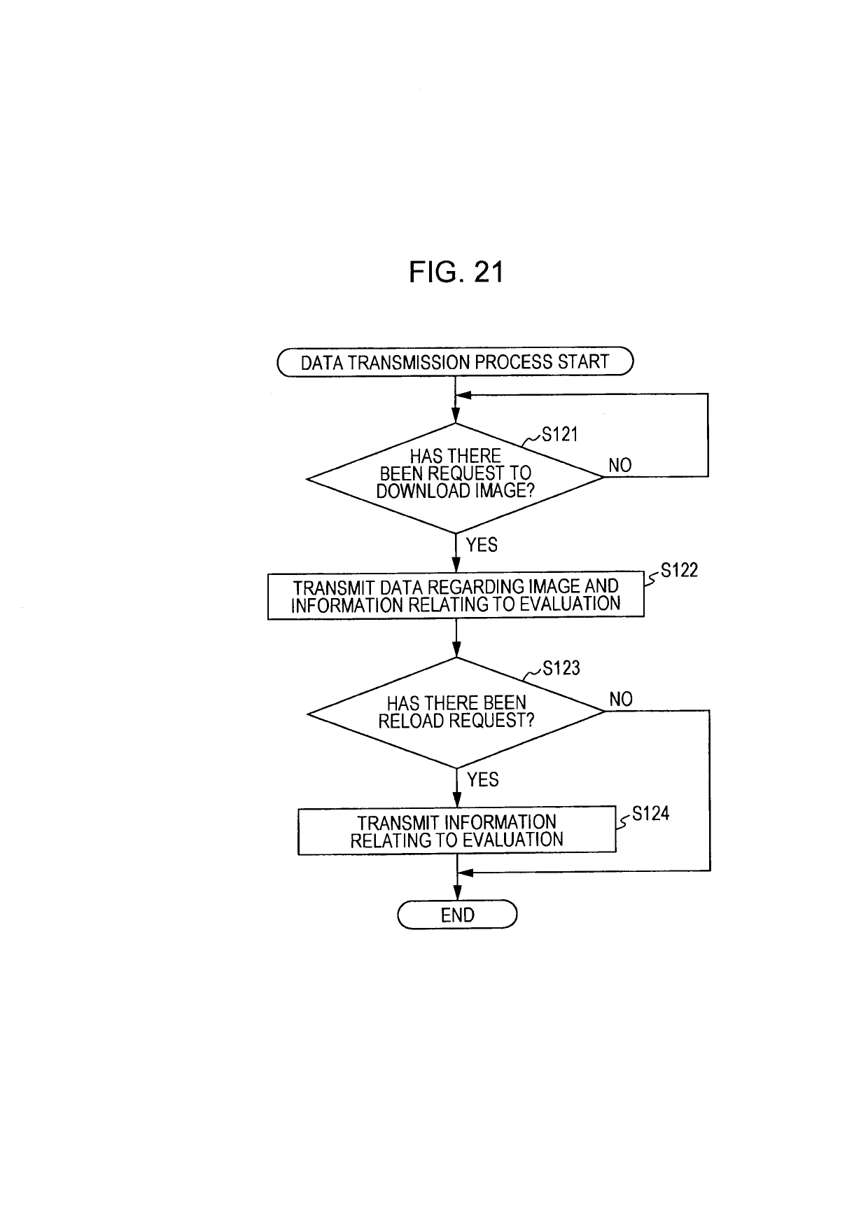

Next, an example of a process for transmitting data executed by the server 22 in accordance with the process for displaying an image illustrated in FIG. 20 will be described with reference to a flowchart of FIG. 21.

In step S121, the CPU 201 of the server 22 judges whether or not there has been a request to download an image, and waits until it is judged that there has been a request to download an image. For example, when a screen such as that illustrated in FIG. 5 has been displayed on the terminal 21, a request to download an image is transmitted to the server 22 from the terminal 21. In step S121, whether or not the request to download an image transmitted from the terminal 21 has been received through the network is judged.

In step S122, the CPU 201 transmits data regarding the image and information relating to evaluation. At this time, the data regarding the image and the information relating to the evaluation are transmitted to the terminal 21, which has transmitted the download request relating to the processing executed in step S121. Thus, the terminal 21 executes download in the processing in step S101 illustrated in FIG. 20.

In step S123, the CPU 201 judges whether or not there has been a reload request. For example, when the reload button 521 displayed on an upper-right portion of the screen illustrated in FIG. 15 has been pressed in the terminal 21, the terminal 21 transmits the reload request to the server 22. The reload request includes information for identifying an image. In step S123, whether or not the reload request transmitted from the terminal 21 has been received through the network is judged.

In step S124, the CPU 201 transmits information relating to evaluation of the image to the terminal 21 in accordance with the reload request relating to the processing executed in step S123. Thus, the terminal 21 executes download in the processing executed in step S107 illustrated in FIG. 20.

If it is judged in step S123 that there has not been a reload request, the process ends.

The process for transmitting data is thus executed.

Although it has been possible to evaluate posted content in the related art, it has been difficult to indicate which part of the content has been evaluated.

For example, if the posted image is a still image obtained by capturing an image of a user, the image of the user, who is the main subject of the image, is not necessarily evaluated, but an image of a pet captured together with the image of the user or an image of a celebrity that has been accidentally captured in the background can often be evaluated. If information indicating which part of content has been evaluated by each person who has viewed the content can be displayed together with the content, a more enjoyable SNS can be provided.

In contrast, according to the present technology, for example, the user can attach a desired mark for evaluation to an arbitrary position in an image to be evaluated, and a mark attached by another user can be superimposed upon the image at a position to which this user has attached the mark. Therefore, information indicating which part of content has been evaluated by each person who has viewed the content can be displayed together with the content.

Therefore, according to the present technology, content can be shared in a more enjoyable manner.

It is to be understood that the above-described series of processes may be executed by hardware or software. When the above-described series of processes is to be executed by software, programs that configure the software are installed in a computer incorporated into dedicated hardware from a network or a recording medium. Alternatively, the programs are installed, from the network or the recording medium, in a general-purpose computer that can execute various functions by installing various programs therein.

When the above-described series of processes is to be executed by software, programs that configure the software are installed from a network such as the Internet or a recording medium such as a removable medium.

It is to be understood that the above-described series of processes herein includes not only processes that are chronologically executed in the specified order but also processes that are not necessarily executed chronologically, that is, processes that are executed parallel to one another or individually.

The embodiments of the present technology are not limited to the above-described embodiments, and can be modified in various ways insofar as the scope of the present technology is not deviated from.

The present technology can also adopt the following configuration.

(1) An apparatus comprising:
an input unit configured to receive an input from a user;
a control unit configured to control a display to
   display an image and an image mark over the image to a position indicated by the input unit, and
   display an indicator showing an amount of time until the image mark is fixed to a current location of the image mark on the image.
      (2) The apparatus of (1), wherein the control unit controls the display to display a plurality of different image marks that each can be selected for movement over the image.
      (3) The apparatus of (1), wherein the control unit controls the display to display the indicator including a numeric indicator displaying the amount of time until the image mark is fixed.
      (4) The apparatus of (1), further comprising:

a communication unit configured to transmit information regarding the image mark to a server after the image mark is fixed.

(5) The apparatus of (4), wherein the communication unit transmits the information including identification information and positional information.
(6) The apparatus of (5), wherein the server stores time information indicating time at which the positional information has been uploaded,

wherein the communication unit downloads the time information together with the positional information, and

wherein the control unit controls the display to displays and superimposes the mark at a position corresponding to the mark in an order corresponding to the time identified by the time information.

(7) The apparatus of (5), wherein the control unit deletes the mark that has been displayed and superimposed when a certain period of time set in advance has elapsed.
(8) The apparatus of (5), wherein the control unit controls display to display or deletes all marks attached to the image at once on the basis of an instruction issued by a user.
(9) The apparatus of (5), wherein the communication unit transmits the identification information including an identifier of the user that fixed the image mark to the image.
(10) The apparatus of (5), wherein the communication unit transmits the positional information including a position on the image where the image mark is fixed.
(11) The apparatus of (4), further comprising:

a feedback unit configured to provide feedback to the user when the communication unit has completed transmitting the information to the server.

(12) The apparatus of (11), wherein the feedback unit vibrates when the communication unit has completed transmitting the information to the server to indicate to the user that the communication unit has finished transmitting the information to the server.
(13) A method comprising:

receiving an input from a user;

displaying an image and an image mark over the image to a position indicated by the input unit, and

displaying an indicator showing an amount of time until the image mark is fixed to a current location of the image mark on the image.

(14) A non-transitory computer readable medium encoded with a program that, when loaded on a processor, causes the processor to perform a method comprising:

receiving an input from a user;

displaying an image and an image mark over the image to a position indicated by the input unit, and

displaying an indicator showing an amount of time until the image mark is fixed to a current location of the image mark on the image.

It should be understood by those skilled in the art that various modifications, combinations, sub-combinations and alterations may occur depending on design requirements and other factors insofar as they are within the scope of the appended claims or the equivalents thereof.

What is claimed is:

1. An apparatus comprising:
an input unit configured to receive an input from a user;
a control unit configured to control a display to
display an image and an image mark over the image to a position indicated by the input unit, and
display an indicator showing an amount of time until the image mark is fixed to a current location of the image mark on the image.

2. The apparatus according to claim 1, wherein the control unit controls the display to display a plurality of different image marks that each can be selected for movement over the image.

3. The apparatus according to claim 1, wherein the control unit controls the display to display the indicator including a numeric indicator displaying the amount of time until the image mark is fixed.

4. The apparatus according to claim 1, further comprising:
a communication unit configured to transmit information regarding the image mark to a server after the image mark is fixed.

5. The apparatus according to claim 4, wherein the communication unit transmits the information including identification information and positional information.

6. The apparatus according to claim 5, wherein the server stores time information indicating time at which the positional information has been uploaded,
wherein the communication unit downloads the time information together with the positional information, and
wherein the control unit controls the display to displays and superimposes the mark at a position corresponding to the mark in an order corresponding to the time identified by the time information.

7. The apparatus according to claim 5, wherein the control unit deletes the mark that has been displayed and superimposed when a certain period of time set in advance has elapsed.

8. The apparatus according to claim 5, wherein the control unit controls display to display or deletes all marks attached to the image at once on the basis of an instruction issued by a user.

9. The apparatus according to claim 5, wherein the communication unit transmits the identification information including an identifier of the user that fixed the image mark to the image.

10. The apparatus according to claim 5, wherein the communication unit transmits the positional information including a position on the image where the image mark is fixed.

11. The apparatus according to claim 4, further comprising:
a feedback unit configured to provide feedback to the user when the communication unit has completed transmitting the information to the server.

12. The apparatus according to claim 11, wherein the feedback unit vibrates when the communication unit has completed transmitting the information to the server to indicate to the user that the communication unit has finished transmitting the information to the server.

13. A method comprising:
receiving an input from a user;
displaying an image and an image mark over the image to a position indicated by the input unit, and
displaying an indicator showing an amount of time until the image mark is fixed to a current location of the image mark on the image.

14. A non-transitory computer readable medium encoded with a program that, when loaded on a processor, causes the processor to perform a method comprising:
receiving an input from a user;
displaying an image and an image mark over the image to a position indicated by the input unit, and
displaying an indicator showing an amount of time until the image mark is fixed to a current location of the image mark on the image.
